(19) United States
(12) Patent Application Publication
(10) Pub. No.: US 2024/0395251 A1
(43) Pub. Date: Nov. 28, 2024

(54) METHODS, SYSTEMS, AND APPARATUSES FOR MODIFYING AUDIO CONTENT

(71) Applicant: Comcast Cable Communications, LLC, Philadelphia, PA (US)

(72) Inventors: Adam Eng, Centennial, CO (US); David Eng, Centennial, CO (US)

(21) Appl. No.: 18/201,584

(22) Filed: May 24, 2023

(51) Int. Cl. G10L 15/26; G10L 13/02; G10L 25/57

(52) U.S. Cl. CPC G10L 15/26; G10L 13/02; G10L 25/57; H04N 21/4884

(57) ABSTRACT

Systems, methods, and apparatuses may be provided for modifying audio content. A content item that includes audio content and video content may be received. The content item may include or be associated with closed captioning data or other text data. The text data and the audio content for the content item may be evaluated to determine when, within the audio content, spoken words are occurring. While the spoken words are occurring in the audio content, the audio content may be modified to reduce or eliminate background noise and other sounds within the audio content that occur at or around the time that the spoken words occur within the audio content.

### BACKGROUND

Hearing loss and difficulty hearing or distinguishing between different types of audio can occur for a number of reasons. The reduction or difficulty in hearing can be both volume based and a reduction of frequencies that can be heard or distinguished by the person. Hearing may be further impacted when there are multiple sound sources or multiple sounds occurring at the same time. For example, when music is playing and a person is speaking, it can be hard for the person to understand what the speaker is saying. This applies to content viewed by persons with hearing loss or hearing difficulties. While combining sounds and speech in content, such as movies or shows, may improve the overall viewing experience for some, for others, especially those with reduced hearing capabilities, this combination of sounds may make it difficult to follow the story being told.

### SUMMARY

It is to be understood that both the following general description and the following detailed description are exemplary and explanatory only and are not restrictive. Methods, systems, and apparatuses systems for analyzing content are described.

A content item that includes audio content and video content may be received. The content item may include or be associated with closed captioning data or other text data. The text data and the audio content for the content item may be evaluated to determine when, within the audio content, spoken dialogue is occurring. While spoken dialogue is occurring in the audio content, the audio content may be modified to reduce or eliminate background noise and other sounds within the audio content that occur during the spoken dialogue.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein:

FIG. 1 shows an example system for modifying audio content;

FIG. 2 shows a block diagram for an example environment for outputting content;

FIG. 3 shows a table of example formatting information for audio content;

FIG. 4 shows a diagram of example text data associated with the audio content;

FIG. 5 shows example metadata for the content item;

FIG. 6 shows a flowchart of an example method;

FIG. 7 shows a flowchart of an example method;

FIG. 8 shows a flowchart of an example method;

FIG. 9 shows a flowchart of an example method; and

FIG. 10 shows a block diagram of an example system and computing device for modifying audio content.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

“Content,” as the phrase is used herein, may also be referred to as “content items,” “content data,” “content information,” “content asset,” or simply “data” or “information”. Content may be any information or data that may be licensed to one or more individuals (or other entities, such as business or group). Content may be electronic representations of video, audio, text and/or graphics, which may be but is not limited to electronic representations of videos, movies, or other multimedia, which may be but is not limited to data files adhering to Moving Pictures Experts Group (MPEG), MPEG2, MPEG4 UHD, HDR, 4k, Adobe® Flash® Video (.FLV) format or some other video file format whether such format is presently known or developed in the future. The content described herein may be electronic representations of music, spoken words, or other audio, which may be but is not limited to data files adhering to the MPEG-1 Audio Layer 3 (.MP3) format, Adobe®, CableLabs 1.0,1.1, 3.0, AVC, HEVC, H.264, Nielsen watermarks, V-chip data and Secondary Audio Programs (SAP). Sound Document (.ASND) format or some other format configured to store electronic audio whether such format is presently known or developed in the future. In some cases, content may be data files adhering to the following formats: Portable Document Format (.PDF), Electronic Publication (.EPUB) format created by the International Digital Publishing Forum (IDPF), JPEG (.JPG) format, Portable Network Graphics (.PNG) format, dynamic ad insertion data (.csv), Adobe® Photoshop® (.PSD) format or some other format for electronically storing text, graphics and/or other information whether such format is presently known or developed in the future. Content may be any combination of the above-described formats.

This detailed description may refer to a given entity performing some action. It should be understood that this language may in some cases mean that a system (e.g., a computer) owned and/or controlled by the given entity is actually performing the action.

Methods, systems and apparatuses are described herein for the analyzing content (e.g., live streaming content, streaming content, stored content, or video-on-demand (VOD) content). The methods, systems, and apparatuses described herein may be employed to evaluate audio and text data associated with the content. The methods, systems, and apparatuses described herein may be further employed to determine when spoken words are included in the audio of a segment of content and filter out, reduce, or remove another portion of audio in the segment of content.

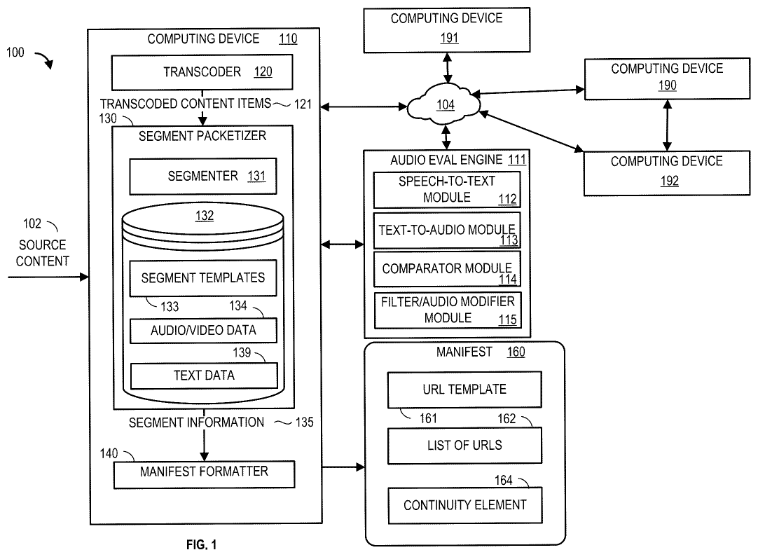

FIG. 1 shows an example system 100 for analyzing content. For example, the system 100 may be configured to analyze text (e.g., closed-caption data, detected text) located within, determined from, and/or associated with the content. The text may include any timed/synchronized display of alphanumeric and/or symbolic characters during output of content (e.g., audio and/or video) for purposes of accessibility (e.g., closed-captioning), translation (e.g., subtitles), and/or any other purpose. For example, text associated with the content may include closed-captioning data, text detected within the content, dialogue provided as text for the content, summaries of the content, descriptions of the content, third-party descriptions of the content, social media descriptions of the content, and the like. For example, the system 100 may be configured to analyze the audio portion of the content (e.g., segments of audio content) to determine spoken words within the audio portion of the content. For example, the system 100 may be configured to determine the spoken words within the audio portion of the content that are associated with, equal, or match a portion of the analyzed text associated with the content. For example, the system 100 may be configured to determine which one or more audio channels of the audio content include the spoken words and filter out, remove, or mute, the other channels of the audio of the content item (e.g., for one or more particular segments of the content item).

The system 100 may be configured to operate as one or more of a content delivery network, a data network, a content distribution network, a combination thereof, and/or the like. The system 100 may include a computing device 110 in communication with a plurality of other devices via a network 104. The network 104 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent on the network 104 via a variety of transmission paths, including wireless paths (e.g., satellite paths, Wi-Fi paths, cellular paths, near-field communication paths, etc.) and terrestrial paths (e.g., wired paths, a direct feed source via a direct line, etc.).

The computing device 110 may be an origin device (e.g., a content origin and/or content source) comprising a server, an encoder, a decoder, a packager, a combination thereof, and/or the like. The computing device 110 may generate and/or output portions of content, such as segments or fragments of encoded content (e.g., content segments). For example, the computing device 110 may convert raw versions of content (e.g., broadcast content) into compressed or otherwise more “consumable” versions suitable for playback/output by user devices, media devices, and other consumer-level computing devices. “Consumable” versions of content—or portions thereof—generated and/or output by an origin computing device may include, for example, data files adhering to H.264/MPEG-AVC, H.265/MPEG-HEVC, H.266/MPEG-VVC, MPEG-5 EVC, MPEG-5 LCEVC, AV1, MPEG2, MPEG, MPEG4 UHD, SDR, HDR, 4k, Adobe® Flash® Video (.FLV), ITU-T H.261, ITU-T H.262 (MPEG-2 video), ITU-T H.263, ITU-T H.264 (MPEG-4 AVC), ITU-T H.265 (MPEG HEVC), ITU-T H.266 (MPEG VVC) or any other video file format, whether such format is presently known or developed in the future. While the computing device 110 is shown as a single device, this is for example purposes only as it is to be understood that the computing device 110 may include a plurality of servers and/or a plurality devices that operate as a system to generate and/or output portions of content, convert raw versions of content (e.g., broadcast content) into compressed or otherwise more “consumable” versions, and/or analyze the content to evaluate the text associated with the content.

The system 100 may include a computing device 190. The computing device 190 may be a form of user device. The computing device 190 may comprise a content/media player, a set-top box, a television, a desktop computer, a laptop computer, a client device, a smart device, a mobile device (e.g., a smart phone, a tablet device, etc.), a caching device (e.g., an edge cache, a mid-tier cache, a cloud cache), a combination thereof, and/or the like. The computing device 110 and the computing device 190 may communicate via the network 104. The computing device 190 may receive portions of requested content items (e.g., audio streams, video streams, audio segments, video segments, audio fragments, video fragments, etc.) and/or information associated with the content (e.g., manifests, text data, formatting information, etc.). The computing device 190 may send requests for portions of the content directly to the computing device 110 or via one or more intermediary computing devices (not shown), such as caching devices, routing devices, etc. While FIG. 1 shows a single computing device 190, this is for example purposes only, and it is to be understood that the system 100 may include a plurality of computing devices (e.g., user devices) that function the same or similarly to the computing device 190.

The computing device 110 may include a plurality of modules/components, such as an transcoder 120, a segment packetizer 130, and/or a manifest formatter 140, each of which may correspond to hardware, software (e.g., instructions executable by one or more processors of the computing device 110), or a combination thereof. The transcoder 120 may perform bitrate conversion, coder/decoder (CODEC) conversion, frame size conversion, etc. For example, the computing device 110 may receive a plurality of source content items 102 associated with a plurality of content channels, and the transcoder 120 may encode each of the source content items 102 to generate one or more transcoded content items 121. The source content items 102 may be live streams of content (e.g., a linear content stream) or a video-on-demand (VOD) content. The computing device 110 may receive the source content items 102 from an external source (e.g., a content channel, a stream capture source, a data storage device, a media server, etc.). The computing device 110 may receive the source content items 102 via a wired or wireless network connection, such as the network 104 or another network (not shown). Although a single source content item 102 is shown in FIG. 1, the computing device 110 may receive any number of source content items 102 for any number of content items and for any number of content channels.

The transcoder 120 may generate a plurality of transcoded content items 121. Each transcoded content item 121 may correspond to a particular adaptive bitrate (ABR) representation of content received via the source content item 102. For example, the plurality of transcoded content items 121 may differ from one other with respect to an audio bitrate(s), a number of audio channels, an audio CODEC(s), a video bitrate(s), a video frame size(s), a video CODEC(s), a combination thereof, and/or the like. The transcoder 120 may encode the source content items 102 such that key frames (e.g., intra-coded frames (I-frames)) in the plurality of transcoded content items 121 occur at corresponding times as in the source content items 102. That is, each of the plurality of transcoded content items 121 derived from a single source of content may be “key frame aligned” to enable seamless switching between different ABR representations by a destination device (e.g., the computing device 190).

The segment packetizer 130 may include a segmenter 131 and a data storage device 132. The data storage device 132 may be a component of the segment packetizer 130, as shown in FIG. 1, or it may be a separate device/entity within the system 100 (e.g., a cache device, data storage repository, database, etc.) in communication with the segment packetizer 130. The segmenter 131 may divide a set of ABR representations of content items (e.g., the plurality transcoded content items 121) into content segments. For example, the segmenter 131 may receive a target segment duration, such as a quantity of milliseconds, seconds, minutes, a particular target data size, etc. The target segment duration may be received via user input (e.g., at the computing device 190 or a user profile); it may be determined via a configuration file at the computing device 110 and/or the computing device 190; it may be determined based on properties of the associated source content items 102; it may be received via the computing device 110; it may be a combination thereof, and/or the like. For example, if the target segment duration is two seconds, the segmenter 131 may segment (e.g., separate, divide, etc.) the plurality of transcoded content items 121 (e.g. a plurality of transcoded audio content items and/or a plurality of transcoded video content items) into a plurality of content segments (e.g., at key frame boundaries). If the transcoded content items 121 include separate video and audio content portions, the segmenter 131 may generate the segments such that the video and audio content segments are timecode aligned. The content segments may comprise a set duration, such as two seconds, depending on a format of the content segments.

The timing data may comprise or indicate a start position/start time of a particular segment and an end position/end time of the particular segment in the source content items 102. For example, the timing data for a particular segment may comprise presentation timestamp (PTS) values that relate a time that the particular segment was encoded and/or transcoded (e.g., by the transcoder 120) to a beginning of the particular content item. The PTS values for a particular segment may ensure that underlying audio/video data 134 (e.g., audio and video frames) for the segment is synchronized.

The computing device 110 may support multiple content segmentation types. The segmenter 131 may generate segments for each of the content segmentation types supported by the computing device 110. Segments may alternately be referred to as “chunks.” The computing device 110 may support both multiplexed segments (video and audio data included in a single multiplexed content segment or stream) and non-multiplexed segments (video and audio data included in separate non-multiplexed content segments or streams). Further, in the case of MPEG-DASH and/or HLS, the computing device 110 may support container formats in compliance with international standards organization base media file format (e.g., ISOBMFF, associated with a file extension “.m4s”), motion picture experts group 2 transport stream (e.g., MPEG-TS), extensible binary markup language (e.g., EBML), WebM, Matroska, or any combination thereof.

The segmenter 131 may employ a “smart” storage system to avoid replicating audio/video data during generation of segments for each content segmentation type. In one example, if the computing device 110 supports N content segmentation types (where N is an integer greater than zero), the segmenter 131 may generate N segment templates 133 for each segment (e.g., two second portion) of each of the transcoded content items 121. Each segment template 133 may comprise header information associated with a content segmentation type, data indicating a start position or start time of the segment in the source content 102, and data indicating an end position or end time of the segment in the source content 102. In the example of MPEG-DASH and/or HLS content, different segment templates may be generated for ISOBMFF multiplexed (“muxed”), ISOBMFF non-multiplexed (“demuxed”), MPEG-TS muxed, MPEG-TS demuxed, EBML muxed, EBML demuxed, etc. Each of the segment templates 133 may not include the underlying audio/video data 134 of the corresponding segment. For example, while multiple segment templates 133 may be generated for each segment of the source content 102, the underlying segment audio/video data 134 may be stored once. As the segment templates 133 are generated, the segmenter 131 may generate and/or send segment information 135 regarding the segment templates 133 and send the segment information 135 to a manifest formatter 140.

The source content items 102 may include text data (e.g., detected text, closed-captioning data/subtitle content data) for or associated with the content item of content. The text data may be encoded into the plurality of transcoded content items 121 by the encoder 120. Each or a portion of the content segments generated by the segmenter 131 may include corresponding text data. The text data may be part of the respective content segments or separately stored in the text data 139 portion of the data storage device 132. For example, the text data may include closed-captioning data adhering to the CEA-608/EIA-708 closed-captions format. For example, the text data may enable a decoder (e.g., at the computing device 190) to decode a particular content segment and present the corresponding video content and audio content with the text data associated with video content and/or audio content embedded therein. The text data for a particular content item (e.g., a particular segment of the content item) may include caption cues indicative of a presentation start time code and a presentation end time code for each portion of the text data associated with the particular content segment, such as one or more spoken words in the content segment or a temporally close (e.g., within a predetermined time or number of segments) content segment, one or more spoken sentences in the content segment or a temporally close content segment, a description (e.g., and indication of a sound occurring, music playing, a description of the scene, etc.), and/or any other information that may be conveyed via text. The presentation timing data and the caption cues for a particular content segment may be used to ensure that text data associated with the content segment is aligned with or close to audio/video data 134 (e.g., encoded video content and/or audio content) during playback (e.g., at the computing device 190).

The segmenter 131 may generate and/or send segment information 135 to a manifest formatter 140. The segment information 135 for a particular segment may refer to (e.g., be indicative of a storage location of) the underlying audio/video data 134 (e.g., audio and video frames) and/or the underlying text associated with the particular segment of the content. The manifest formatter 140 may generate playlists or manifests based on the segment information 135 received from the packager 130. The playlists or manifests may comprise manifest files, such as MPEG-DASH media presentation description (MPD) files for MPEG-DASH and/or HLS content. The manifest formatter 140 may generate one or more playlists (e.g., manifests). If the manifest type is number-based or time-based, the manifest formatter 140 may generate, based on the segment information 135, a manifest 160 that comprises a URL template 161. The URL template 161 may be number-based or time-based. A URL template 161 that is number-based may be used by the computing device 190 to construct URLs to request individual segments according to corresponding segment number. A URL template 161 that is time-based may be used by the computing device 190 to construct URLs to request individual segments according to corresponding segment start time. If the manifest type is list-based, the manifest formatter 140 may generate, based on the segment information 135, a manifest 160 that comprises a list of URLs 162. The list of URLs may include URLs that are specific to one or more segments of one or more ABR representations.

A different manifest may be generated for each computing device (e.g., computing device 190) that requests a manifest for a particular content item, even if two or more computing devices specify the same manifest type and content segmentation type. For example, the manifest 160 may be specific to the computing device 190. Each URL or URL template in the manifest 160 may include embedded session information that identifies the computing device 190. The session information may be used to uniquely identify the requester of a segment.

The system 100 may comprise a computing device 192. The computing device 192 may be sent to a packaging device, such as a just-in-time packager. The computing device 192 may be in communication with each device shown in the system 100. The computing device 192 may receive the manifest 160 in addition to the computing device 190. The computing device 192 may receive requests for the content item (e.g., requests for segments (e.g., portions) of a content item) from the computing device 190 according to the manifest 160. The computing device 192 may retrieve corresponding transcoded segments of the content from the computing device 110, prepare the transcoded segments for output by the computing device 190, and deliver the requested segments to the computing device 190. The manifest 160 may indicate first timing data, such as a first presentation time stamp (PTS) associated with the transcoder 120. The first PTS may be used by the computing device 192 to determine at what point in time a particular segment requested by the computing device 190 is to be delivered—or otherwise made available to—the computing device 190.

The system 100 may comprise a computing device 191. The computing device 191 may be a content origin server(s) and/or a network of content origin servers. The computing device 191 may function similarly to the computing device 110. For example, the computing device 191 may serve as a backup for the computing device 110 in the event the computing device 110 fails or is otherwise unable to process a request. The computing device 110 may serve as a backup for the computing device 191 in the event the computing device 191 fails or is otherwise unable to process a request.

The system 100 may include an audio evaluation engine 111. The audio evaluation engine 111 may be part of the computing device 110 or may be a separate computing device in communication with computing device 110 via a network (e.g., the network 104 or another network (not shown)). The audio evaluation engine 111 may include a single computing device, or it may comprise a system/network of computing devices.

The audio evaluations engine 111 may include a speech-to-text module 112, a text-to-audio module 113, a comparator module 114, and/or a filter/audio modifier module 115. The comparator module 114 may be configured to compare the text data for the source content item 102 to the audio for the source content item 102 to determine when portions of the audio match or are substantially the same as the text associated with source content item 102. For example, the comparator module 114 may compare the text data for the source content item 102 to the audio for the source content item 102 by converting the audio for the source content item to text using the speech-to-text module 112 and comparing the audio text to the text data for the source content item 102. For examples where multiple channels of audio data (e.g., stereo sound, 5-1 surround sound, 7-1 surround sound, etc.) are provided for the source content item 102 (e.g., each segment of the source content item), the speech-to-text module 112 may convert the audio data for each channel of audio to text for the source content item 102 (e.g., on a segment-by-segment basis). The comparator module 114 may then compare each channel of audio text to the text data to determine which of the one or more channels of audio data includes the spoken words indicated in the text data.

For example, the comparator module 114 may compare the text data for the source content item 102 to the audio for the source content item 102 by converting the text data to audio and comparing the converted audio to the audio for the source content item to determine if the converted audio is the same or sufficiently similar to the audio for the source content item 102. For examples where multiple channels of audio data (e.g., stereo sound, 5-1 surround sound, 7-1 surround sound, etc.) are provided for the source content item 102 (e.g., each segment of the source content item), the comparator module 114 may compare the converted audio to each channel of audio for the source content item (e.g., on a segment-by-segment basis) to determine which of the one or more channels of audio for all or a portion of a content item (e.g., all or a portion of a segment of the content item) is the same or sufficient similar to the converted audio created from the text data.

For example, the comparator module 114 may access the text data associated (e.g., for) the source content item 102 or for a particular content segment of the source content item 102. The text data may include one or a plurality of text data items. Each text data item may represent text that is to be displayed with the video of the source content item 102. Each text data item may comprise one or more words or symbols that are intended to be displayed at or near the same time (e.g., scrolling of the text within a text item may occur over a couple seconds of time). The text data items may include text of words spoken in the audio of the source content item, text of sound descriptions for sounds occurring in the audio of the source content item 102, text of scene descriptions for scenes shown in the video of the source content item 102, etc. Each of the types of text data items may be configured to be displayed with the video of the source content item 102. For example, the text data items may be displayed as an overlay over a portion of the video, at the bottom or below the video, at the top or above the video, or in a picture-in-picture format with the video for the source content item 102. For example, the text data 139 or the text data associated with (e.g., provided with) the source content 102 (e.g., particular segment of the source content 102) may include one or more text data items. Each text data item may include or be associated with a presentation time. The presentation time may indicate the time within the video of the source content item 102 that the particular text data item is to be displayed or begin to be displayed. For example, the comparator module 114 or another portion of the audio evaluation engine 111 may determine a one or more portions of audio for the source content item (e.g., one or more segments of the source content item) to evaluate based on the presentation time associated with a particular text data item. For example, the comparator module 114 may determine to evaluate the portion of audio for the source content item (e.g., the segment of audio) that covers (e.g., includes the audio for) the presentation time associated with the particular text data item. For example, the comparator module 114 may also determine to evaluate one or more additional portions or segments of audio occurring before or after the presentation time associated with the particular text data item. For example, the number of segments to evaluate before or after the segment of audio that covers the presentation time, may be a pre-set number of segments or may be determined based on a pre-set amount of time for segments before and after the segment of audio covering the presentation time. For example, the computing device 110 or audio evaluation engine 111 may include a buffer configured to contain the number of segments to be evaluated to account for the time difference between when the audio occurs in the source content item 102 and when the text data is configured to be displayed.

The speech-to-text module 112 may be configured to convert audio data to written text (e.g., converted audio text). For example, the speech-to-text module 112 may be configured to convert the audio of the audio content for the source content item 102 (e.g., on a segment-by-segment basis) to converted audio text that indicates the spoken words and a description of the other noises, sounds, music, etc. included in the audio for the audio content for the source content item 102.

The text-to-audio module 113 may be configured to convert text data (e.g., text data 139 for the source content item 102) into an audio track that includes audio of the text within the text data being audibly spoken. This text may include the speech or spoken words within the content item and descriptions of scenes, sounds, music, actions occurring in the content item that are not the speech or spoken words within the audio of the content item. For example, the text-to-audio module 113 may receive all or particular portions of the audio content for the received source content item 102 (e.g., a plurality of content segments for the source content item) from the computing device 110. For example, the audio evaluation engine 111 may retrieve the text data (e.g., closed-captioning data) for the source content item 102. For example, the text data may be retrieved from a plurality of content segments for the source content item or from the text data 139.

The comparator module 114 may determine which portions of content include the audio comprising the spoken words corresponding to or associated with (e.g., matching or substantially matching) all or a portion of a particular text data item of the text data. The determining can be done on a segment-by-segment basis, or any other process desired based on, e.g., content format. The comparator module 114 may also determine which if particular one or more channels of audio, for the content comprising multi-channel audio content, include audio comprising spoken words or speech (e.g., character's spoken lines within the content) corresponding to or associated with (e.g., matching or substantially matching) a particular text data item of the text data for the content item. This may allow for isolating the one or more channels of audio content that include the audio that comprises the spoken words/speech from the one or more other channels that do not include the audio that comprises the spoken words or speech. The one or more channels that do not include the audio that comprises the spoken words/speech may be removed or filtered out of the audio content for the content item. The one or more channels that do include the audio that comprises the spoken words/speech may be replicated and played on the removed or filtered out channels of audio for the content.

The filter/audio modifier module 115 may be configured to modify or create/add (e.g., muxing or transcoding the content an additional time) additional audio tracks of the source content item 102. For example, the filter/audio modifier module 115 may be configured to modify the audio of the source content item 102, e.g., on a segment-by-segment basis, that includes the audio comprising spoken words associated with all or the portion of the particular text data item of the text data. For example, the filter/audio modifier module 115 may be configured to filter out the portion of the audio data for the content (e.g., the content segment) that is not associated with (e.g., does not make up) the spoken words within the audio data. For example, the filter/audio modifier module 115 may use auto-tuning to filter out background noise that is not associated with the spoken words within the audio data for the content (e.g., the content segment). For example, the filter/audio modifier module 115 may modify the frequency (e.g., increase the frequency or decrease the frequency) of the audio data associated with (e.g., making up) the spoken words within the audio data. For example, the filter/audio modifier module 115 may modify the volume (e.g., increase the volume) of the audio data associated with (e.g., making up) the spoken words within the audio data. The filter/audio modifier module 115 may add the newly created audio track to the audio (e.g., one or more segments) of the content item. For example, the computing device 110 may transcode (e.g., via the transcoder 120) the audio (e.g., the one or more audio segments) to include the newly created audio track or an indicator of the location of the audio (e.g., the audio segments) for the newly created audio track that includes (e.g., only includes) the spoken words within the audio data. For example, the added audio track for the content item (e.g., the one or more segments of the added audio track) may indicate that it is for users with difficulty hearing or hearing loss.

For example, in a multi-channel audio segment where only a portion of the channels of audio data comprise the spoken words associated with the text data item, the filter/audio modifier module 115 may be configured to modify one or more of the current tracks of audio or create a new track of audio in order to mute or delete the one or more other channels that do not comprise the audio data of the spoken words, for that segment of content. For example, the filter/audio modifier module 115 may be configured to replace the one or more other channels that do not comprise the audio data of the spoken words with one of the channels of audio data for that content segment that includes the audio data comprising the spoken words associated with the text data item. For example, the filter/audio modifier module 115 may be configured to create a new track of audio for the segment that includes multiple channels of audio and in which the audio data of the spoken words is configured to be output on all or multiple channels of the net track of audio.

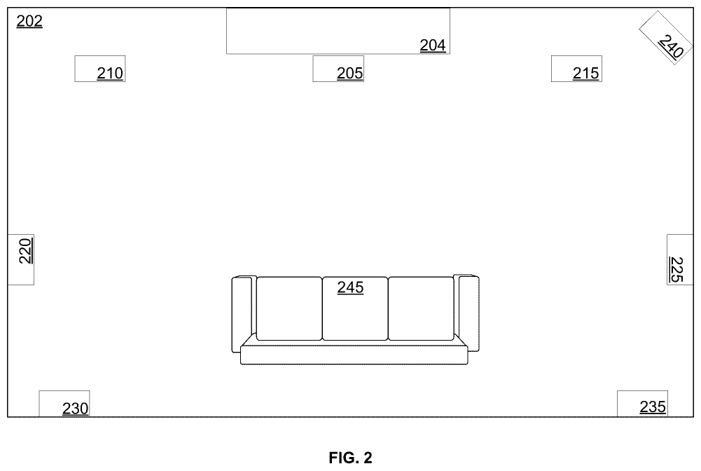

FIG. 2 shows a block diagram for an example environment 202 for outputting content. For example, the content may be audio content or audio/video content. For example, the content may be linear content (e.g., live content or content currently being broadcast on a channel) or on-demand content. The content may include video content, audio content, and text data associated with the video content and audio content. For example, the text data may comprise closed-captioning text data. The environment 202 may be a room or area within residence or other building.

The environment 202 may include a video display device 204 and one or more speakers 205-240. For example, the speaker layout of the example environment is a 7-1 surround sound speaker layout. However, other speaker layouts are available, and the position of each speaker shown is for example purposes only as other speaker positions may be chosen based on the specific factors of a particular environment. For example, the speaker layout may not include one or more of the speakers shown or may include additional speakers not shown. Other example layouts include, but are not limited to, a 5-1 surround sound speaker layout, a stereo (e.g., 2-speaker layout), or any other speaker layout. The video display device 204 may be a television, a monitor, a screen for a projection system or the like. For example, the display device 204 may be the computing device 190 or communicably coupled (e.g., wired or wirelessly) to the computing device 190. The display device 204 may be configured to output audio and/or video content.

The speakers may include a front center speaker 205. For example, the front center speaker 205 may be positioned behind, below, above, or in front of the display device 204 and may be generally centered along the front of the room or other environment 202. For audio content that includes multiple channels of content, the channel of content that is sent to the front center speaker 205 may be the center channel audio content. For example, the center channel audio content may be designated or indicated by the reference “C” within the multiple channels of audio content.

The speakers may include a front left speaker 210. For example, the front left speaker 210 may be positioned to the left of the display device 204 (when viewing the front of the display device 204) and may be generally on the left side of the front wall of the room or other environment 202. For audio content that includes multiple channels of content, the channel of content that is sent to the front left speaker 210 may be the left channel audio content. For example, the left channel audio content may be designated or indicated by the reference “L” within the multiple channels of audio content.

The speakers may include a front right speaker 215. For example, the front right speaker 215 may be positioned to the right of the display device 204 (when viewing the front of the display device 204) and may be generally on the right side of the front wall of the room or other environment 202. For audio content that includes multiple channels of content, the channel of content that is sent to the front right speaker 215 may be the right channel audio content. For example, the right channel audio content may be designated or indicated by the reference “R” within the multiple channels of audio content.

The speakers may include a surround left speaker 220. For example, the surround left speaker 220 may be positioned along the left wall or side of the room or other environment 202. For audio content that includes multiple channels of content, the channel of content that is sent to the surround left speaker 220 may be the surround left channel audio content. For example, the surround left channel audio content may be designated or indicated by the reference “Ls” within the multiple channels of audio content.

The speakers may include a surround right speaker 225. For example, the surround right speaker 225 may be positioned along the right wall or side of the room or other environment 202. For audio content that includes multiple channels of content, the channel of content that is sent to the surround right speaker 225 may be the surround right channel audio content. For example, the surround right channel audio content may be designated or indicated by the reference “Rs” within the multiple channels of audio content.

The speakers may include a back left speaker 230. For example, the back left speaker 230 may be positioned behind the seating 245 or area where the people viewing the display device 204 are expected to be positioned. For example, the back left speaker 230 may be positioned on the left side of the back wall of the room or other environment 202. For audio content that includes multiple channels of content, the channel of content that is sent to the back left speaker 230 may be the surround left channel audio content.

The speakers may include a back right speaker 235. For example, the back right speaker 235 may be positioned behind the seating 245 or area where the people viewing the display device 204 are expected to be positioned. For example, the back right speaker 235 may be positioned on the right side of the back wall of the room or other environment 202. For audio content that includes multiple channels of content, the channel of content that is sent to the back right speaker 235 may be the surround right channel audio content.

The speakers may include a subwoofer speaker 240. For example, the subwoofer speaker 240 may be positioned along the front wall, the back wall or anywhere else in the room or other environment 202. For audio content that includes multiple channels of content, the channel of content that is sent to the subwoofer speaker 240 may be the low-frequency effects channel audio content. For example, the low frequency effects channel audio content may be designated or indicated by the reference “LFE” within the multiple channels of audio content.

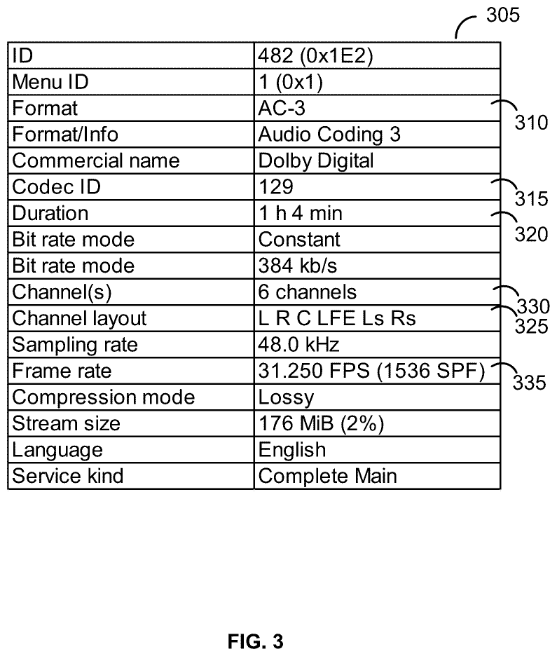

FIG. 3 shows a table 305 of example formatting information for the audio content. For example, the information shown in the table 305 may be sent with and received with the audio content. For example, the information in the table 305 may be provided as part of a file. For example, the information in the table 305 may be included in the metadata for the audio content. For example, the information in the table 305 may be included in the metadata for the content received by the computing device 110. For example, the information in the table 305 may be included with the metadata the content (e.g., each segment of the content) being received by the computing device 190, the display device 204, or any other user device receiving the content. The information in the table 305 is provided for example purposes only. Additional information or less information may be provided with the content in other examples.

For example, the table 305 may include an indicator of the audio content format 310. For example, the audio content format 310 may indicate the format of the audio content and the number of audio files or channels of audio content for the content or content segment. For example, the computing device 110 may evaluate the information to determine the audio content format and, based on the format, the number of channels of audio content that are received and will be included the content (e.g., for each content segment of the content item). For example, the computing device 110 and/or control device 111 may determine, based on the audio content format 310, the number of audio channels of the audio content that need to be evaluated or which audio channels of the audio content to evaluate to identify a portion of the audio that includes spoken words that are associated with the text data for the content. For example, certain channels of the audio content may not be evaluated to identify the portion of the audio that includes spoken words that are associated with the text data for the content. For example, some channels of the audio content may be unlikely or less likely to include spoken words within the audio for that particular channel. For example, audio designated for the low-frequency effects channel, the surround left channel, and/or the surround right channel may be less likely to include spoken words within the audio designated for those channels. As such, those channels may not be evaluated or may be evaluated after the other remaining channels of audio content for the content item are evaluated when searching for spoken words within the audio content that is associated with (e.g., matches or nearly matches) the text data. For example, some channels of the audio content may be more likely to include spoken words with the audio for that particular channel. Based on the audio content format 310, the computing device 110 and/or control device 111 may prioritize certain channels of the audio content to evaluate when searching for spoken words within the audio content that is associated with the text data. For example, the center channel of audio content may have the highest priority and may be evaluated first. For example, the left and right channels of audio content may have a higher priority than any other channels of audio content (other than the center channel of audio content) and may be evaluated by the computing device 110 or control device 111 after evaluating the center channel of audio content. For example, the computing device 190 may evaluate the information to determine the audio content format 310, and accordingly, the number of channels of audio content to be played for the content. In the example table 305, the audio content format is AC-3 or audio codec 3. AC-3 is a 5-1 surround sound audio content format. While the example table 305 shows the audio content form as AC-3, any other audio content format may be indicated and determined by the computing devices 110, 111, 190, including, but not limited to MP3, advanced audio coding (AAC), windows media audio (WMA), linear pulse code modulation (LPCM), digital theater sound (DTS) surround, enhanced AC-3 (E-AC-3), DTS-HD, Atmos, and the like.

For example, the table 305 may include a codec identifier 315. The codec identifier may indicate the codec that was used to encode the audio content. The table 305 may include the duration 320 of the audio content. The duration 320 may be represented in hours, minutes, and seconds, in minutes, in seconds, or as a counter variable. The table 305 may include the bit rate 325 that the audio content is encoded at.

The table 305 may include the number of channels 330 of audio content being provided in the audio content for the particular content item. In the example table 305, six channels 330 of audio content are being provided for the audio content of the content item. This may correspond to a 5-1 surround sound format. However, in other examples, the number of channels provided for the audio content can be greater or lesser than six channels and can include one or more channels of audio content.

The table 305 may include the channel layout 325 for the channels 330 provided for the audio content. For example, the channel layout 325 may indicate the order of the channels of the audio content for the content item and may indicate the speakers (if available) that each particular channel of audio content may be sent to. For example, the channel layout 325 indicates that the first audio file for the audio content is associated with the L or front left channel, and the audio file is intended to be output at the front left speaker (e.g., front left speaker 210). For example, the channel layout 325 indicates that the second audio file for the audio content is associated with the R or front right channel and the audio file is intended to be output at the front right speaker (e.g., front right speaker 215). For example, the channel layout 325 indicates that the third audio file for the audio content is associated with the C or center channel and the audio file is intended to be output at the front center speaker (e.g., front center speaker 205). For example, the channel layout 325 indicates that the fourth audio file for the audio content is associated with the LFE or low frequency effects channel and the audio file is intended to be output at the subwoofer speaker (e.g., subwoofer speaker 240). For example, the channel layout 325 indicates that the fifth audio file for the audio content is associated with the Ls or surround left channel and the audio file is intended to be output at the surround left speakers (e.g., surround left speaker 220 and back left speaker 230). For example, the channel layout 325 indicates that the sixth audio file for the audio content is associated with the Rs or surround right channel and the audio file is intended to be output at the surround right speaker (e.g., surround right speaker 225 and back right speaker 230). Other channel layout options may alternatively be provided and the order of the files of the channels of audio may also be modified in other examples. The table 305 may include any other information pertinent to decoding and playing the audio content for the content item. For example, the table 305 may include any one or more of an audio ID that identifies the audio content, a menu ID, a commercial name for the audio content format, a sampling rate, a frame rate 335, a compression mode, a stream size, and the language of the audio content.

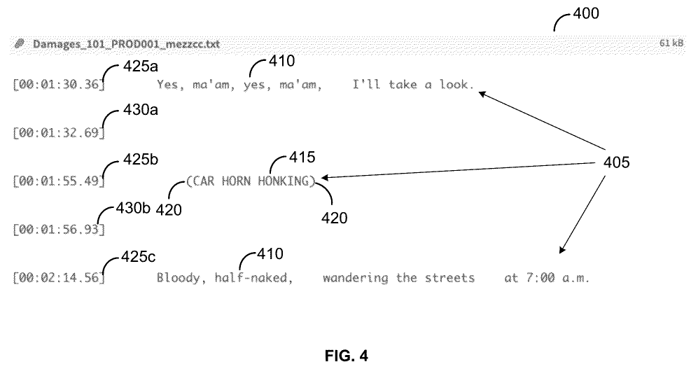

FIG. 4 shows an example diagram 400 of text data associated with the content item. For example, the text data may be included in a closed captioning file, in metadata associated with the content item or provided in another manner. The data may include the text data items 405. The text data items 405 may indicate or represent the spoken words or sounds that are included in the audio content for the content item. For example, the text data items 405 may include spoken text items 410 and sound text items 415. The spoken text items 410 may indicate or represent the spoken words (e.g., actor's lines, narrator's lines, reporter's statements, etc.) in the audio content for the content item. The sound text item 415 may indicate or represent sounds that are occurring (e.g., explosion, boom, soft music playing, car horn honking, etc.) within the audio content for the content item.

The text data may include sound text indicators 420. The sound text indicators may provide an indication as to when the text data is for a sound text item 415 rather than a spoken text item 420. For example, the sound text indicator 420 can be parentheses “(” or brackets “[ ]” with the sound text item 415 in between the parentheses or brackets. For example, a computing device (e.g., the comparator module 114 of the control device 111 or computing device 110 may detect the sound text indicator 420 when evaluating the text data associated with the audio content and may determine to skip or not evaluate the sound text item 415 within the sound text indicator 420 as the sound text item is not associated with spoken words within the audio content for the content item.

The text data may include presentation start times 425a-c and presentation end times 430a-b. Each presentation start time 425a-c may indicate the time within the content item that the text data item 405 should be displayed or begin to be displayed (for rolling text) with the video content for the content item. For example, the presentation start time 425a-c may be a clock, timer, or counter associated with the runtime for the video content for the content item. For example, the presentation start time 425a-c may be during the same time within the audio content that the spoken words or sounds associated with the particular text item 405 occurs. In other examples, the presentation start time 425a-c may be before (e.g., 0.01-10 seconds before) or after (e.g., 0.01-10 seconds after) the spoken words or sounds associated with the particular text item 405 occurs. For example, for live broadcasts, it may be typical for the text items 405 to be delayed or occurring after the spoken words or sounds associated with the particular text item 405 occurs.

The text data may include presentation end times 430a-b. Each presentation end time 430a-b may indicate the time within the content item that the text data item is no longer displayed and is removed from the video content of the content item. For example, the presentation end time 430a-b may be a clock, timer, or counter associated with the runtime for the video content for the content item. For example, the presentation end time 430a-b for a text data item 405 may also be a presentation start time 425a-c for another text data item 405 or may remove all text from the output of the video content until another text data item 405 is to be displayed.

For example, a computing device (e.g., the comparator module 114 of the control device 111 or computing device 110) may determine a text data item 405 within the text data. The computing device may determine the text data item 405 is a spoken text item 410. For example, the computing device may determine the text data item 405 is a spoken text item based on the text data item 405 not including one or more sound text indicators 420. The computing device, based on determining the text data item 405 is a spoken text item 410, may determine the presentation start time 425a-c for the spoken text item.

For example, based on the presentation start time 425a-c, the computing device may invoke the speech-to-text module 112 to convert the audio content at or near the corresponding presentation start time 425a-c within the audio content to text. For example, the time period of the audio content converted from speech to text may be based on the presentation start time 425a-c for the spoken text item 410. For example, the time period may include a predetermined amount of time before and after the presentation start time. For example, the time period may include a predetermined amount of time before the presentation start time 425a-c and a predetermined amount of time after the presentation end time 430a-b for the spoken text item 410. For example, the predetermined amount of time may be 5 seconds, 10 seconds, 20 seconds, or any other amount of time.

The computing device, (e.g., the comparator module 114) may compare the spoken text item 410 to the converted audio text determined by the speech-to-text module 112 from the audio content for the content item to determine if any portion of the converted audio text is associated with (e.g., matches or substantially matches) the spoken text item 410. For example, a portion of the converted audio text may be associated with the spoken text item 410 if the correspondence (e.g., matching) between the converted audio text and the spoken text item 410 satisfies a correspondence threshold. For example, the correspondence threshold may be any value, such as any value between 50%-100%. For example, 50% correspondence between the converted audio text and the spoken text item 410 may occur when half the words in the spoken text item match words and/or presentation order within at least a portion of the converted audio text. For audio content that includes multiple channels of audio content for the content item, the computing device may evaluate one or more of the channels of audio content to determine which channel or channels of the audio content include converted audio text that is associated with the spoken text item.

For example, based on at least a portion of the converted audio text being determined to be associated with the spoken text item, the computing device (e.g., the comparator module 114) may determine an output time for the audio content corresponding to the associated converted audio text. For example, the computing device may determine the start output time for the associated converted audio text and the end output time for the associated converted audio text. For example, the computing device, based on the start output time and the end output time, may determine the portion of the audio content for the content item (e.g., the one or more segments of the audio content) that include audio content represented by the associated converted audio text. For example, filtering, channel muting, and or channel audio content replication may be determined based on one or more of the start output time, end output time, and the determined portion of the audio content for the content item (e.g., segments of the audio content for the content item).

For example, the computing device may invoke the text-to-audio module 113 to convert the spoken text item 410 to a converted audio item comprising an audio rendition of the spoken text item 410. The computing device (e.g., the comparator module 114) may, based on one or more of the presentation start time 425a-c and presentation end time 430a-b for the particular spoken text item 410, determine a time period for a portion of the audio content for the content item to evaluate. For example, the time period may include a predetermined amount of time before and after the presentation start time. For example, the time period may include a predetermined amount of time before the presentation start time 425a-c and a predetermined amount of time after the presentation end time 430a-b for the particular spoken text item 410. For example, the predetermined amount of time may be 5 seconds, 10 seconds, 20 seconds, or any other amount of time.

The computing device, (e.g., the comparator module 114) may compare the converted audio item to the audio content for the content item to determine if any portion of the converted audio item is associated with (e.g., matches or substantially matches) all or a portion of the audio content during the evaluated time period. For example, the converted audio item may be associated with the at least a portion of the audio content for the content item if the correspondence (e.g., matching) between the converted audio item and the audio content satisfies a correspondence threshold. For example, the correspondence threshold may be any value, such as any value between 50%-100%. For example, 50% correspondence between the converted audio item and the audio content for the content item may occur when the audio for half the words in the audio content for the content item match words and/or presentation order within at least a portion of the converted audio item. For audio content that includes multiple channels of audio content for the content item, the computing device may evaluate one or more of the channels of audio content to determine which channel or channels of the audio content include audio content that is associated with the converted audio item.

For example, based on at least a portion of the audio content being determined to be associated with the converted audio item, the computing device (e.g., the comparator module 114) may determine an output time for the audio content corresponding to the associated converted audio item. For example, the computing device may determine the start output time for the associated audio content and the end output time for the associated audio content. For example, the computing device, based on the start output time and the end output time, may determine portion of the audio content (e.g., the segments of the audio content on a segment-by-segment basis) that include audio content associated with the converted audio item. For example, filtering, channel muting, and or channel audio content replication may be determined based on one or more of the start output time, end output time, and the determined audio content (e.g., the segments of the determined audio content).

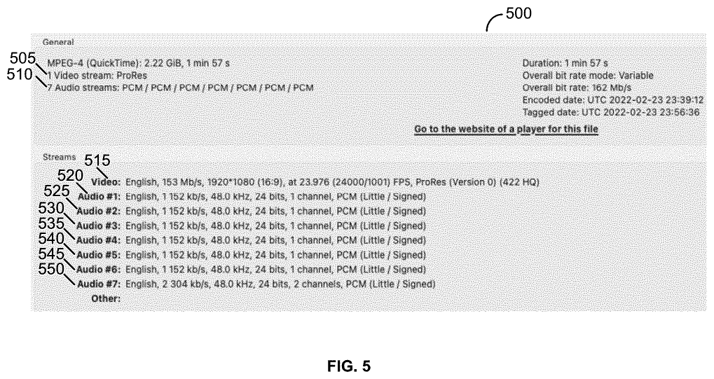

FIG. 5 shows example media header information 500 for a content item. For example, the media header information may comprise technical and tag information about the video and/or audio files for the content item. The media header information 500 may be provided with, included in, or otherwise associated with the content item. For example, the media header information 500 may be provided with, included in, or otherwise associated with each of the plurality of content segments of the content item. The media header information 500 may include a video content indicator 505. The video content indicator 505 may indicate the number of streams of video content being provided for the content item. The video content indicator may indicate the video codec used to encode the video content.

The media header information 500 may include an audio content indicator 510. The audio count indicator 510 may indicate the number of channels of audio content being provided for the content item. The audio content indicator 510 may also indicate the audio codec used to encode each of the channels of audio content. For example, the audio content indicator 510 indicates the codec for each of the channels of audio content is pulse code modulation.

The media header information 500 may include information 515 associated with or about the video content for the content item. The video content information 515 may also indicate one or more of the bit rate for the video content, the screen resolution for the video content, the frame rate of the video content, and video codec used to encode the video content.

The media header information 500 may include an information of one or more audio tracks 520-550 for the one or more channels of audio content. For example, a separate audio track 520-545 may be provided for each or certain channels of the audio content. For example, an audio track 550 may be provided for multiple channels of the audio content. For example, audio tracks 1-6 520-545 may be separate audio tracks for each channel of a 5-1 audio system. For example, audio track 7 550 may be a track that is configured to be played on both channels of a stereo audio system. The audio track information 520-550 may also indicate other information about the audio content. For example, the audio track information 520-550 for the audio content may indicate one or more of the bit rate for the particular audio track of the audio content, the frequency for audio track of the audio content, and the audio codec used to encode the audio track of the audio content.

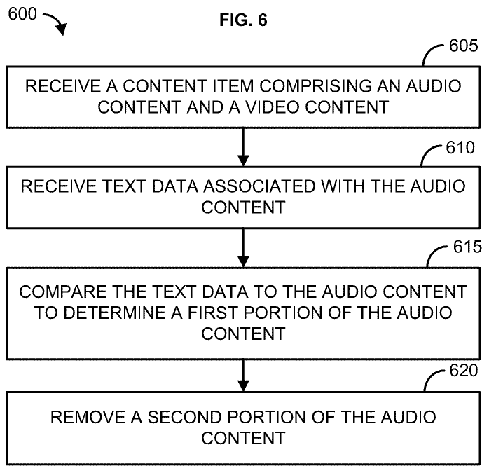

FIG. 6 shows a flowchart of an example method 600 for modifying audio content for a content item. For example, the audio content may be modified by a computing device (e.g., the control device 111, the computing device 110, or the computing device 190). For example, at 605, a content item may be received by the computing device 110 from one or more content sources 102. The content item may include video content and audio content. The audio content may include one or more channels of audio content for the content item. For example, the audio content may include a plurality of channels of audio content associated with a surround sound output objective. For example, the audio content may include 5, 6, 7, 8, or more channels of audio content for the content item. Each channel of audio content may be output at one or more designated speakers in a viewing environment. For example, the computing device 110 may, via the transcoder 120, transcode the audio content and the video content. The computing device 110, via the segmenter 131, may divide the video content into a plurality of video content segments and the audio content (e.g., each channel of the audio content or all of the channels of the audio content combined) into a plurality of audio content segments. The plurality of segments may be multiplexed segments, having video content and audio content (e.g., each channel of the audio content) in one segment or non-multiplexed segments, having separate video content segments and audio content segments. For example, the non-multiplexed audio content segment may include audio data for each channel of the audio content for the corresponding video segment.

At 610, text data associated with the audio content of the content item may be received. For example, the text data may be received by the audio evaluation engine 111, the computing device 110, the computing device 190 or any other computing device. The text data may be associated with speech or spoken words. For example, the received text data may be text data associated with the content item (e.g., one or multiple segments of the content item). For example, the text data may be encoded into the transcoded content items 121 by the encoder 120. Each or a portion of the content (e.g., content segments) generated by the segmenter 131 may include corresponding text data. The text data may be part of the respective content (e.g., content segment) or separately stored in the text data 139 portion of the data storage device 132. For example, the text data may include closed-captioning data adhering to the CEA-608/EIA-708 closed-captions format. For example, the text data may enable a decoder (e.g., at the computing device 190) to decode the particular content (e.g., on a segment-by-segment basis) and present the corresponding video content and audio content with the text data associated with video content and/or audio content embedded therein.

For example, the text data may include spoken text items and sound text items. The spoken text items may indicate or represent the speech or spoken words (e.g., actor's lines, narrator's lines, reporter's statements, etc.) in the audio content for the content item. The sound text item may indicate or represent sounds that are occurring (e.g., explosion, boom, soft music playing, car horn honking, etc.) within the audio content for the content item.

For example, the text data may include sound text indicators. The sound text indicators may provide an indication as to when the text data is for a sound text item rather than a spoken text item. For example, the sound text indicator can be parentheses “(” or brackets “[ ]” with the sound text item in between the parentheses or brackets. For example, a computing device (e.g., the comparator module 114 of the audio evaluation engine 111, computing device 110, or computing device 190) may detect the sound text indicator when evaluating the text data associated with the audio content and may determine to skip or not evaluate the sound text item within the sound text indicator as the sound text item is not associated with spoken words within the audio content for the content item.

The text data may include presentation start times and/or presentation end times. Each presentation start time may indicate the time within the content item that the text data item should be displayed or begin to be displayed (for rolling text) with the video content for the content item. For example, the presentation start time may be a clock, timer, or counter associated with the runtime for the video content for the content item. For example, the presentation start time may be during the same time within the audio content that the spoken words or sounds associated with the particular text item occurs. In other examples, the presentation start time may be before (e.g., 0.01-10 seconds before) or after (e.g., 0.01-10 seconds after) the spoken words or sounds associated with the particular text item occurs.

The text data may include presentation end times. Each presentation end time may indicate the time within the content item that the text data item is no longer displayed and is removed from the video content of the content item. For example, the presentation end time may be a clock, timer, or counter associated with the runtime for the video content for the content item.

For example, a computing device (e.g., the comparator module 114 of the audio evaluation engine 111, the computing device 110, or the computing device 190) may determine a text data item within the text data. For example, the computing device 114 may determine the text data item is associated with speech (e.g., a spoken text item). For example, the computing device may determine the text data item is associated with speech based on the text data item not including one or more sound text indicators. The computing device, based on determining the text data item is associated with speech, may determine the presentation start time and/or presentation end time for the spoken text item of the text data.

Audio content for the content item may be received. For example, audio content for the content item may be received (e.g., audio content for one or multiple segments of the content item). For example, the audio content may be received by the audio evaluation engine 111, the computing device 110, or the computing device 190. For example, the audio content may be received based on the text data item. For example, the audio content for the content item may be received based on the presentation start time and/or the presentation end time for the spoken text item in the text data. For example, the audio content for the content item (e.g., one or more segments of the content item) may be received based on the presentation start time and/or the presentation end time for the spoken text item in the text data. For example, the audio content may be for the portion of the content item (e.g., one or more segments of the content item) that has an output time that is between the presentation start time and the presentation end time for the spoken text item within the text data and/or within a predetermined amount of time before the presentation start time or a predetermined amount of time after the presentation end time for the spoken text item in the text data. For example, the predetermined amount of time may be 5 seconds, 10 seconds, 20 seconds, or any other amount of time.

The computing device may determine one or more spoken words within the audio content of the content item (e.g., on a segment-by-segment basis for the one or more content segments of the content item). For example, the computing device may convert all or at least a portion of the received audio content for the content item (e.g., on a segment-by-segment basis) into converted audio text. For example, the computing device may invoke the speech-to-text module 112 to convert the received audio content at or near the corresponding presentation start time within the audio content to converted audio text. For example, the time period of the audio content converted from speech to converted audio text may be based on the presentation start time for the spoken text item. For example, the time period may include a predetermined amount of time before and after the presentation start time. For example, the time period may include a predetermined amount of time before the presentation start time and a predetermined amount of time after the presentation end time for the spoken text item in the text data. For audio content comprising multiple channels of audio content for the content item (e.g., for each content segment of the content item), the computing device may invoke the speech-to-text module 112 to convert each channel of audio content to converted audio text, may only convert a portion of the channels of the audio content (e.g., the center, left and right channels) to converted audio text, or only convert a single channel (e.g., the center channel) of the audio content to converted audio text.

At 615, the text data may be compared to the audio content to determine a first portion of the audio content. For example, the first portion of the audio content may comprise audio that corresponds to or is associated with the text data. For example, the corresponding or associated audio may include spoken words that match all or a portion of the text data. For example, the comparison may be made by the comparator module 114, the computing device 110, or the computing device 190. For example, the comparison may be based on the text data, the audio, and/or the converted audio text for the content item (e.g., one or more content segments of the content item). For example, the first portion of the audio content may be determined to be corresponding to or associated with the text data based on at least a portion of the converted audio text of the audio for the content item (e.g., one or more content segments) that includes the audio content being associated with (e.g., matching or substantially matching) all or a portion of the spoken text item of the text data. For example, determining the audio for the first portion of the audio content corresponds to or is associated with the text data comprises determining the text data matches or substantially matches one or more spoken words in the audio for first portion of the audio content. For example, determining the audio for the first portion of the audio content corresponds to or is associated with the text data comprises determining a portion of the converted audio text of the audio for the first portion of the audio content corresponds to or is associated with the text data. For example, based on the correspondence or association, the computing device may determine the one or more spoken words in the audio of the audio content for the content item (e.g., one or more content segments of the content item) matches at least a portion of the text data. For example, the first portion of the audio content may comprise one or more spoken words associated with the text data and non-speech audio (e.g., background sounds, background music, car honking, explosion, door knock, etc.).

For example, based on the text data (e.g., the spoken text item) the computing device may determine that the text data is associated with one or more spoken words within the audio of the portion of the audio content of the content item (e.g., audio content for the one or more content segments of the content item). For example, the computing device, (e.g., the comparator module 114) may compare the spoken text item to the converted audio text determined by the speech-to-text module 112 from the audio of the audio content for the content item (e.g., a portion such as one or more segments of the content item) to determine if any portion of the converted audio text corresponds to or is associated with (e.g., matches or substantially matches) the spoken text item of the text data. For example, a portion of the converted audio text may correspond to or be associated with the spoken text item if the correspondence (e.g., matching) between the converted audio text of the audio and the spoken text item satisfies a correspondence threshold. For example, the correspondence threshold may be any value, such as any value between 50%-100%. For example, 50% correspondence between the converted audio text and the spoken text item in the text data may occur when half the words in the spoken text item match the words and/or the presentation order within at least a portion of the converted audio text. For audio content that includes multiple channels of audio content for the content item, the computing device may evaluate one or more of the channels of audio content to determine which channel or channels of the audio content include converted audio text that is associated with the spoken text item.

For example, the computing device may evaluate all of the channels of the audio content for the content item (e.g., on a segment-by-segment basis) to determine which channel or channels of the audio content are associated with the text data. For example, the computing device may evaluate only a portion or subset of the channels of the audio content to determine which channel or channels of the audio content are associated with the text data. For example, the portion of the channels may comprise one or more of the center channel the left channel and the right channel of the audio content. For example, the potion of the channels to be evaluated may not include one or more of the LFE channel, the surround right channel, the surround left channel, or any channel of audio content designated for the back left and back right speakers in a surround sound system. These channels may not be a portion of the channels evaluated due to the reduced likelihood that spoken words in the audio content are to be output on those channels of the audio content.

For example, the computing device may prioritize evaluating one or more channels of the audio content over one or more other channels of the audio content. For example, the center channel of audio content for the content item (e.g., one or more content segments of the center channel of audio content) may be prioritized to be evaluated first. Prioritizing the center channel of the audio content may be based on the higher likelihood that spoken words in the audio content are more likely to be output from the center channel of audio content than any other channel of the audio content. For example, the center channel, the left channel and the right channel may be prioritized to be evaluated for audio content associated with the text data over any other channels of the audio content.

For example, the computing device may determine the first portion of the audio content associated with the text data by determining a first portion of the plurality of the channels of audio content comprise one or more spoken words in the audio data for the first portion of the channels of the audio content that are associated with the text data.

For example, based on the audio for the first portion of the audio content (e.g., at least a portion of the converted audio text) being determined to correspond to or be associated with the text data (e.g., the spoken text item in the text data), the computing device (e.g., the comparator module 114) may determine an output time for the audio content corresponding to the associated converted audio text. For example, the computing device may determine the start time for the first portion of the audio content and the end time for the first portion of the audio content. For example, the computing device may determine the start time for when the spoken words within the audio of the audio content that correspond to or are associated with the text data begin to be spoken and when the spoken words corresponding to or associated with the text data end being spoken to determine the particular time range within the content item (e.g., the audio of the audio content for the content item) that the spoken words are output. For example, the start time and the end time may be clock references (e.g., times) or counter references and may be based on the beginning of the content item or another time reference. For example, the computing device, based on the start time and the end time, may determine the portion of the audio content for the content item (e.g., one or more segments of the audio content (or segments and channels of the audio content)) that include the audio for the first portion of the audio content corresponding to or associated with the text data.

At 620, a second portion of the audio content for the one or more content segments may be removed or filtered out. For example, the removal and/or filtering may be caused or conducted by the filter/audio modifier module 115, the computing device 110, or the computing device 190. For example, the second portion of the audio content may or may not include the first portion of the audio content associated with the text data.

For examples where multiple channels of the audio content are provided for each of the one or more segments of the content item, the second portion of the audio content may be removed or filtered by removing, deleting, muting, not playing, and/or modifying the audio for one or more channels of the audio content that are not associated with the text data. For example, the following channels of audio content may be provided for each content segment: R channel audio content, L channel audio content, C channel audio content, LFE channel audio content, Rs channel audio content, and Ls channel audio content. The computing device may determine that the C channel audio content includes the audio for the first portion of the audio content that corresponds to or is associated with the text data (e.g., the C channel audio content includes one or more spoken words that match or substantially match the text data). This may be for one or more content segments of the content item depending, for example, on the start time and the end time. The computing device may determine that the R, L, LFE, Rs and Ls channels of audio content do not include audio that corresponds to or is associated with the text data (e.g., the channels do not include the spoken words that match or substantially match the text data but may include other sound data). The computing device may create a new track of audio for the one or more content segments. The new track of audio may comprise audio for one channel or multiple channels (e.g., all channels). In another example, the computing device may modify the existing tracks of audio for the one or more content segments.

For example, the computing device may remove or filter the audio for the R, L, LFE, Rs, and Ls channels of audio content for those one or more content segments. For example, the computing device may generate a new audio track for the one or more content segments whereby the C channel of audio content, or a portion of the C channel audio content, is included in the new audio track for the one or more content segments and the R, L, LFE, Rs, and Ls channel audio content are not included or the C channel audio data is replicated for output on the R, L, LFE, Rs, and Ls channels by replicating the C channel audio content for each of the other channels of audio content. This may occur in a single audio track that includes the six channels of audio content or in six audio tracks, one for each of the R, L, LFE, Rs, Ls, and C channels of audio content for the one or more content segments. The computing device may create the new audio track or tracks by muxing or transcoding the one or more content segments a second time to create the new audio track or tracks. The new track or tracks may then be included with and/or associated with the one or more segments of the content item that included the audio data of the spoken words. These new audio tracks or tracks may be provided as an alternative option for those one or more segments along with the original tracks of audio for the one or more segments of the audio content.

In addition, or in another example, the computing device may modify the manifest for the one or more content segments to include an indication (e.g., URL or storage location) for the one or more content segments of one or more alternative sets of audio tracks (e.g., the C channel of audio content or a booth recording that includes a spoken-voice only track, which may be provided by the content source) for selection and output when the version of the content item for those with difficulty hearing or hearing loss is selected.

For examples where the original audio tracks for the content item may be modified (rather than creating new tracks that are included with the original audio tracks) to remove, filter, mute or remove the non-spoken words in the audio data for the content item, the computing device may remove, delete, or mute or indicate that those channels of audio content (e.g., the R, L, LFE, Rs, and Ls channels) should be muted within, for example, the metadata associated with the one or more content segments. For example, when the channels of audio content are muted or deleted, the audio content associated with those channels will not be output at the respective speaker position when the one or more segments of the content item are output at a user device (e.g., computing device 190). For example, the computing device may remove or filter the second portion of the audio content by modifying one or more of the R, L, LFE, Rs, or Ls channels of audio content. For example, the computing device may replace the audio content for one or more of the R, L, LFE, Rs, or Ls channels with the audio content for the C channel. As such, the computing device may replace the second portion of the audio content in certain channels with the audio for the first portion of the audio content from another channel that corresponds to or is associated with the text data. This will further remove the audio content that is associated with non-speaking audio and replace it with additional sources of the audio content that includes the spoken words in the audio content. Those of ordinary skill in the art will recognize that the specific channels described above are for example purposes only and that different channels and different groups of channels may be included in and include the first portion of the audio content or the second portion of the audio content in other examples.

For example, the second portion of the audio content may be removed or filtered using auto-tuning. For example, the computing device may identify a waveform in the first portion of the audio content and corresponding to or associated with (e.g., the audio data representing) the spoken words in the audio content. For example, the computing device may clean up the waveform, to make the spoken words clearer when output. For example, the computing device may remove or filter out the second portion of the audio content by deleting other waveforms associated with other audio (e.g., audio data) that is also occurring between the start time and the stop time of the first portion of the audio content. For example, removing or filtering out the second portion of the audio content may comprise removing or filtering out all audio not corresponding to or associated with the text data in the audio for the audio content for the one or more content segments. This may occur when new tracks are being created or when the original tracks are being modified.

The computing device may also modify the first portion of the audio content that is associated with the text data. For example, the computing device may modify one or more of the frequency, pitch, or volume of the first portion of the audio content that corresponds to or is associated with the text data. For example, the computing device may increase the volume of the first portion of the audio content in an effort to make it easier to hear the spoken words within the first portion of the audio content. The computing device may increase or decrease the frequency of the first portion of the audio content to a frequency range that is easier for certain users to hear and recognize. The filtered or modified audio content for the one or more segments of the content item, as well as the associated video content for those segments of the content item, may be sent to a user device (e.g., the computing device 190) and output at the user device. This may occur when new tracks are being created or when the original tracks are being modified.

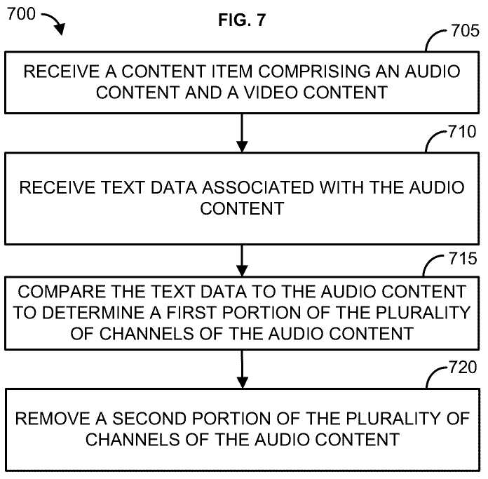

FIG. 7 shows a flowchart of an example method 700 for modifying audio content for a content item. For example, the audio content may be modified by a computing device (e.g., the control device 111, the computing device 110, or the computing device 190). For example, at 705, content item may be received by the computing device 110 from one or more content sources 102. The content item may include video content and audio content. The audio content may comprise audio (e.g., audio data). The audio content may include a plurality of channels of audio content associated with a surround sound output objective for the content item. For example, the audio content may include 5, 6, 7, 8, or more channels of audio content for the content item. Each channel of audio content may be output at one or more designated speakers in a viewing environment. For example, the computing device 110 may, via the transcoder 120, transcode the audio content and the video content. The computing device 110, via the segmenter 131, may divide the video content into a plurality of video content segments (e.g., video segments) and the audio content (e.g., each channel of the audio content or all of the channels of the audio content combined) into a plurality of audio content segments (e.g., audio segments). The plurality of content segments may be multiplexed segments, having video content and audio content (e.g., each channel of the audio content, such as audio/video segments) in one segment or non-multiplexed segments, having separate video content segments and audio content segments. For example, the non-multiplexed audio content segment may include the audio data for each channel of the audio content for the corresponding video segment.

At 710, text data associated with the audio content of the content item may be received. For example, the text data may be received by the audio evaluation engine 111, the computing device 110, the computing device 190, or any other computing device. The text data may be associated with speech or spoken words. For example, the received text data may be text data associated with one or multiple segments of the content item. For example, the text data may be encoded into the transcoded content items 121 by the transcoder 120. Each or a portion of the content segments generated by the segmenter 131 may include corresponding text data. The text data may be part of the respective content segments or separately stored in the text data 139 portion of the data storage device 132. For example, the text data may include closed-captioning data adhering to the CEA-608/EIA-708 closed-captions format. For example, the text data may enable a decoder (e.g., at the computing device 190) to decode a particular content segment and present the corresponding video content and audio content with the text data associated with video content and/or audio content embedded therein.

For example, the text data may include spoken text items and sound text items. The spoken text items may indicate or represent the speech or spoken words (e.g., actor's lines, narrator's lines, reporter's statements, etc.) in the audio content for the content item. The sound text item may indicate or represent sounds that are occurring (e.g., explosion, boom, soft music playing, car horn honking, etc.) within the audio content for the content item.

For example, the text data may include sound text indicators. The sound text indicators may provide an indication as to when the text data is for a sound text item rather than a spoken text item. For example, the sound text indicator can be parentheses “( )” or brackets “[ ]” with the sound text item in between the parentheses or brackets. For example, a computing device (e.g., the comparator module 114 of the audio evaluation engine 111, computing device 110, or computing device 190) may detect the sound text indicator when evaluating the text data associated with the audio content and may determine to skip or not evaluate the sound text item within the sound text indicator as the sound text item is not associated with spoken words within the audio content for the content item.

The text data may include presentation start times and/or presentation end times. Each presentation start time may indicate the time within the content item that the text data item should be displayed or begin to be displayed (for rolling text) with the video content for the content item. For example, the presentation start time may be a clock, timer, or counter associated with the runtime for the video content for the content item. For example, the presentation start time may be during the same time within the audio content that the spoken words or sounds associated with the particular text item occurs. In other examples, the presentation start time may be before (e.g., 0.01-20 seconds before) or after (e.g., 0.01-20 seconds after) the spoken words or sounds associated with the particular text item occurs.

The text data may include presentation end times. Each presentation end time may indicate the time within the content item that the text data item is no longer displayed and is removed from the video content of the content item. For example, the presentation end time may be a clock, timer, or counter associated with the runtime for the video content for the content item. For example, the presentation start time for the next entry of text data may be the presentation end time for the prior entry of text data.

For example, a computing device (e.g., the comparator module 114 of the audio evaluation engine 111, the computing device 110, or the computing device 190) may determine a text data item within the text data. For example, the computing device 114 may determine the text data item is associated with speech (e.g., a spoken text item). For example, the computing device may determine the text data item is associated with speech based on the text data item not including one or more sound text indicators. The computing device, based on determining the text data item is associated with speech, may determine the presentation start time and/or presentation end time for the spoken text item of the text data.

Audio content for the content item may be received. For example, a plurality of channels of audio content for the content item (e.g., one or more content segments of the content item) may be received or determined. For example, the plurality of channels of audio content may be received or determined by the audio evaluation engine 111, the computing device 110, or the computing device 190. For example, the plurality of channels of audio content may be received or determined based on the text data item. For example, the plurality of channels of audio content for the content item may be received based on the presentation start time and/or the presentation end time for the spoken text item in the text data. For example, the plurality of channels of audio content for the one or more segments of the content item may be received or determined based on the presentation start time and/or the presentation end time for the spoken text item in the text data. For example, the plurality of channels of audio content may be for one or more segments of the content item that have an output time that is between the presentation start time and the presentation end time for the spoken text item within the text data and/or within a predetermined amount of time before the presentation start time or a predetermined amount of time after the presentation end time for the spoken text item in the text data. For example, the predetermined amount of time may be 5 seconds, 10 seconds, 20 seconds, or any other amount of time.

The computing device may determine one or more spoken words within one or more of the plurality of channels of audio content for the one or more content segments. For example, for each channel of the plurality of channels of audio content, the computing device may convert all or at least a portion of the received channel of audio content for the one or more content segments into converted audio text, if any spoken words are included in the channel of audio content. For example, the computing device may invoke the speech-to-text module 112 to convert the received audio content at or near the corresponding presentation start time within the audio content to converted audio text. For example, the time period of the audio content converted from speech to converted audio text may be based on the presentation start time for the spoken text item. For example, the time period may include a predetermined amount of time before and after the presentation start time. For example, the time period may include a predetermined amount of time before the presentation start time and a predetermined amount of time after the presentation end time for the spoken text item in the text data. For example, the computing device may invoke the speech-to-text module 112 to convert each channel of audio content to converted audio text, may only convert a portion of the channels of the audio content (e.g., the center, left and right channels) to converted audio text, or only convert a single channel (e.g., the center channel) of the audio content to converted audio text.

At 715, the text data may be compared to the one or more of the plurality of channels of audio content to determine a first portion of the plurality of channels of audio content. For example, the first portion of the plurality of channels of audio content may comprise audio that corresponds to or is associated with the text data. For example, the corresponding or associated audio may include spoken words that match all or a portion of the text data. For example, the comparison may be made by the comparator module 114, the computing device 110, or the computing device 190. For example, the comparison may be based on the text data, the audio of the audio content for the one or more of the plurality of channels of audio content, and/or the converted audio text from the audio for the one or more channels of audio content for the one or more content segments of the content item. For example, the first portion of the audio content may be determined to be corresponding to or associated with the text data based on at least a portion of the converted audio text of the audio for the one or more channels of audio content for one or more content segments that includes the audio content being associated with (e.g., matching or substantially matching) all or a portion of the spoken text item of the text data. For example, determining the audio for the first portion of the audio content corresponds to or is associated with the text data comprises determining the text data matches or substantially matches one or more spoken words in the audio for the first portion of the audio content. For example, determining the audio for the first portion of the audio content corresponds to or is associated with the text data comprises determining a portion of the converted audio text of the audio for the first portion of the audio content for the one or more of the plurality of channels of audio content corresponds to or is associated with the text data. For example, based on the correspondence or association, the computing device may determine the one or more spoken words in audio of one or more channels of audio content for the one or more content segments matches at least a portion of the text data. For example, the first portion of the audio content may comprise one or more spoken words that correspond to or are associated with the text data and non-speech audio (e.g., background sounds, background music, car honking, explosion, door knock, etc.).

For example, based on the text data (e.g., the spoken text item) the computing device may determine that the text data is associated with one or more spoken words within the audio of the portion of one or more channels of the audio content in the one or more content segments. For example, the computing device, (e.g., the comparator module 114) may compare the spoken text item to the converted audio text for one or more (e.g., each) channels of audio content determined by the speech-to-text module 112 from the audio of one or more channels of audio content for the content item (e.g., for the one or more segments of the content item) to determine if any portion of the converted audio text from the audio of any of the one or more channels of audio content corresponds to or is associated with (e.g., matches or substantially matches) the spoken text item of the text data. For example, a portion of the converted audio text may correspond to or be associated with the spoken text item if the correspondence (e.g., matching) between the converted audio text of the audio and the spoken text item satisfies a correspondence threshold. For example, the correspondence threshold may be any value, such as any value between 50%-100%. For example, 50% correspondence between the converted audio text and the spoken text item in the text data may occur when half the words in the spoken text item match the words and/or the presentation order within at least a portion of the converted audio text. Accordingly, the computing device may evaluate one or more of the channels of audio content to determine which channel or channels of the audio content include converted audio text that is associated with the spoken text item.

For example, the computing device may evaluate all of the channels of the audio content for the one or more content segments to determine which channel or channels of the audio content are associated with the text data. For example, the computing device may evaluate only a portion or subset of the channels of the audio content to determine which channel or channels of the audio content are associated with the text data. For example, the portion of the channels may comprise one or more of the center channel the left channel and the right channel of the audio content. For example, the potion of the channels to be evaluated may not include one or more of the LFE channel, the surround right channel, the surround left channel, or any channel of audio content designated for the back left and back right speakers in a surround sound system. These channels may not be a portion of the channels evaluated due to the reduced likelihood that spoken words in the audio content are to be output on those channels of the audio content.

For example, the computing device may prioritize evaluating one or more channels of the audio content over one or more other channels of the audio content. For example, the center channel of audio content for the one or more content segments may be prioritized to be evaluated first. Prioritizing the center channel of the audio content may be based on the higher likelihood that spoken words in the audio content are more likely to be output from the center channel of audio content than any other channel of the audio content. For example, the center channel, the left channel and the right channel may be prioritized to be evaluated for audio content associated with the text data over any other channels of the audio content.

For example, the computing device may determine the audio for the first portion of the audio content corresponds to or is associated with the text data by determining a first portion of the plurality of the channels of audio content comprise one or more spoken words in the audio data for the first portion of the channels of the audio content that are associated with the text data.

For example, based on the audio for the first portion of the audio content (e.g., at least a portion of the converted audio text) in one or more of the plurality of channels of audio content being determined to correspond to or be associated with the text data (e.g., the spoken text item in the text data), the computing device (e.g., the comparator module 114) may determine an output time for the audio content corresponding to the associated converted audio text. For example, the computing device may determine the start time for the first portion of the audio content in at least one channel of the audio content and the end time for the first portion of the audio content in the at least one channel of the audio content. The determination of the start and stop time in one channel of the audio content may be indicative of the start and stop time of all of the channels of the audio content that include the first portion of the audio content. For example, the computing device may determine the start time for when the spoken words within the audio of the audio content that correspond to or are associated with the text data begin to be spoken and when the spoken words corresponding to or associated with the text data end being spoken within at least one channel of the audio content to determine the particular time range within one or more of the plurality of channels of audio content for the one or more content segments (e.g., the audio of the audio content for the content item) that the spoken words are output. For example, the start time and the end time may be clock references (e.g., times) or counter references and may be based on the beginning of the content item or another time reference. For example, the computing device, based on the start time and the end time, may determine the one or more segments and channels of the audio content that include the audio for the first portion of the audio content corresponding to or associated with the text data.

At 720, a second portion of the plurality of channels of the audio content for the one or more content segments may be removed or filtered out. For example, removal and/or filtering may be caused or conducted by the filter/audio modifier module 115, the computing device 110, or the computing device 190. For example, the second portion of the audio content may or may not include the first portion of the audio content associated with the text data.

For example, the second portion of the plurality of channels of the audio content may be removed or filtered by removing, deleting, muting, not playing, and/or modifying the audio for one or more channels of the audio content that are not associated with the text data. For example, the original audio tracks for the one or more segments of the content item may be modified to remove, delete, mute, and/or not play the second portion of the plurality of channels. For example, the second portion of the plurality of channels of the audio content may be removed or filtered by auto-tuning a portion of the channel of audio content that includes the audio content associated with the text data. For example a new audio track or tracks for the one or more segments may be created and added to or associated with the one or more content segments. These new audio tracks may be in addition to the original audio track or tracks for each of the one or more segments of the content item. The new track or tracks may only include the first portion of the plurality of channels or may include a replication of one or more of the first portion of the plurality of channels of audio to be output on the channels associated with the second portion of the plurality of channels of the audio content.

For example, the following channels of audio content may be provided for each content segment: R channel audio content, L channel audio content, C channel audio content, LFE channel audio content, Rs channel audio content, and Ls channel audio content. The computing device may determine that the C channel audio content is the only channel that includes the audio for the first portion of the audio content that corresponds to or is associated with the text data (e.g., the C channel audio content includes one or more spoken words that match or substantially match the text data)(e.g., the first portion of the plurality of channels of the audio content). This may be for one or more content segments of the content item depending, for example, on the start time and the end time. The computing device may determine that the audio for the R, L, LFE, Rs and Ls channels of audio content do not include audio that corresponds to or is associated with the text data (e.g., the channels do not include the spoken words that match or substantially match the text data but may include other sound data). The computing device may modify the current track or tracks of audio for the one or more content segments or may create a new track of audio for the one or more content segments. The new track of audio may comprise audio for one channel or multiple channels (e.g., all channels).

For example, the computing device may remove or filter the R, L, LFE, Rs, and Ls channels of audio content for those one or more content segments. For example, the computing device may generate a new audio track for the one or more content segments whereby the first portion of the plurality of channels of the audio content (e.g., in this example the C channel of audio content, or a portion of the C channel audio content), is included in the new audio track for the one or more content segments and the R, L, LFE, Rs, and Ls channel audio content (e.g., the second portion of the plurality of channels of audio content) are not included, or the C channel audio data (or in other examples where multiple channels are within the first portion of the plurality of channels of audio content, one or more of those channels) is replicated for output on the R, L, LFE, Rs, and Ls channels by replicating the C channel audio content for each of the other channels of audio content. This may occur in a single audio track that includes the six channels of audio content or in six audio tracks, one for each of the R, L, LFE, Rs, Ls, and C channels of audio content for the one or more content segments. The computing device may create the new audio track or tracks by muxing or transcoding the one or more content segments a second time to create the new audio track or tracks. The new track or tracks may then be included with and/or associated with the one or more segments of the content item that included the audio data of the spoken words. These new audio tracks or tracks may be provided as an alternative option for those one or more segments along with the original tracks of audio for the one or more segments of the audio content.

In addition, or in another example, the computing device may modify the manifest for the one or more content segments to include an indication (e.g., URL or storage location) for the one or more content segments of one or more alternative sets of audio tracks (e.g., the C channel of audio content or a booth recording that includes a spoken-voice only track, which may be provided by the content source) for selection and output when the version of the content item for those with difficulty hearing or hearing loss is selected.

For examples where the original audio tracks for the content item may be modified (rather than creating new tracks that are included with the original audio tracks) to filter, mute or remove the non-spoken words in the audio data for the content item, the computing device may delete or mute or indicate that those channels of audio content (e.g., the R, L, LFE, Rs, and Ls channels) should be muted within, for example, the metadata associated with the one or more content segments. For example, when the channels of audio content are removed, muted, or deleted, the audio content associated with those channels will not be output at the respective speaker position when the one or more segments of the content item are output at a user device (e.g., computing device 190). For example, the computing device may remove or filter the second portion of the audio content by modifying one or more of the R, L, LFE, Rs, or Ls channels of audio content (e.g., the second portion of the plurality of channels of audio content). For example, the computing device may replace the audio content for one or more of the R, L, LFE, Rs, or Ls channels with the audio content for the C channel (e.g., the first portion of the plurality of channels of audio content). As such, the computing device may replace the audio for the second portion of the plurality of channels of audio content in certain channels with the audio (e.g., audio data) from the first portion of the plurality of channels of audio content from another channel that corresponds to or is associated with the text data. This will further remove the audio content that is associated with non-speaking audio and replace it with additional sources of the audio content that includes the spoken words in the audio content. Those of ordinary skill in the art will recognize that the specific channels described above are for example purposes only and that different channels and different groups of channels may be included in and include the first portion of the audio content or the second portion of the audio content in other examples.

For example, the computing device may remove or filter out of the audio content from the C channel of audio content (e.g., the first portion of the plurality of channels of audio content), that also includes the audio content that is associated with the text data, the portion of the audio content that does not correspond to or is not associated with the text data (e.g., background noise, music, etc.). For example, the computing device may identify a waveform in the portion of the audio (e.g., audio data) of the audio content that is associated with (e.g., the audio data representing) the spoken words in the audio content. For example, the computing device may clean up the waveform, to make the spoken words clearer when output. For example, the computing device may remove or filter out the portion of the audio in the audio content in the C channel of audio content that does not correspond to or is not associated with the text data by deleting other waveforms associated with other audio data that is also occurring between the start time and the stop time of the portion of the audio content within the C channel of audio content. For example, removing or filtering out the portion of the audio of the audio content that does not correspond to or is not associated with the text data/spoken words may comprise removing or filtering out all audio in the C channel of audio content that does not correspond to or is not associated with the text data for the one or more content segments of the content item.

The computing device may also modify the portion of the audio content that is associated with the text data. For example, the computing device may modify one or more of the frequency, pitch, or volume of the portion of the audio content in the C channel of audio content that corresponds to or is associated with the spoken words/text data. For example, the computing device may increase the volume of the portion of the audio content for the first portion of the plurality of channels of audio content for the one or more content segments in an effort to make it easier to hear the spoken words within the portion of the audio content. The computing device may increase or decrease the frequency of the portion of the audio content for the first portion of the plurality of channels of audio content to a frequency range that is easier for certain users to hear and recognize. The filtered or modified audio content for the one or more segments of the content item, as well as the associated video content for those segments of the content item, may be sent to a user device (e.g., the computing device 190) and output at the user device. Those of ordinary skill in the art will recognize that the specific channels described above are for example purposes only and that different channels and different groups of channels may be included in and include the first portion of the audio content or the second portion of the audio content in other examples.

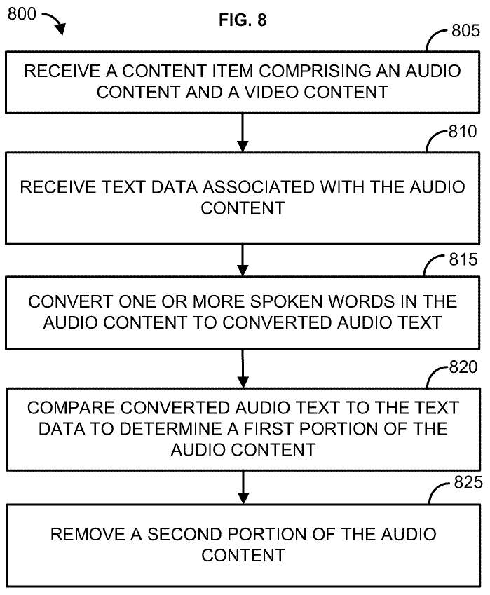

FIG. 8 shows a flowchart of an example method 800 for modifying audio content for a content item. For example, the audio content may be modified by a computing device (e.g., the control device 111, the computing device 110, or the computing device 190). For example, at 805, a content item may be received by computing device. For example, the content item may be received from one or more content sources 102. The content item may include video content and/or audio content. The audio content may be associated with the video content for a content item such that the audio content and the video content are configured to be output with one another. The audio content may include one or more channels of audio content for the content item. For example, the audio content may include a plurality of channels of audio content associated with a surround sound output objective. For example, the audio content may include 5, 6, 7, 8, or more channels of audio content for the content item. Each channel of audio content may be output at one or more designated speakers in a viewing environment.

For example, the audio content and the video content may be divided into a plurality of content segments for the content item. The plurality of segments may be multiplexed segments, having video content and audio content (e.g., each channel of the audio content or all of the channels of the audio content) in one segment or non-multiplexed segments, having separate video content segments and audio content segments (e.g., one or multiple channels of audio content in each content segment). For example, the non-multiplexed audio content segment may include the audio data for each channel of the audio content for the corresponding video segment.

At 810, text data associated with the audio content of the content item may be received. For example, the text data may be received by the audio evaluation engine 111, the computing device 110, the computing device 190 or any other computing device. The text data may be associated with speech or spoken words in the audio content. For example, the received text data may be text data associated with one or multiple segments of the content item. For example, the text data may be encoded into the transcoded content items 121 by the encoder 120. Each or a portion of the content segments generated by the segmenter 131 may include corresponding text data. The text data may be part of the respective content segments or separately stored in the text data 139 portion of the data storage device 132. For example, the text data may include closed-captioning data adhering to the CEA-608/EIA-708 closed-captions format. For example, the text data may enable a decoder (e.g., at the computing device 190) to decode a particular content segment and present the corresponding video content and audio content with the text data associated with video content and/or audio content embedded therein.

For example, the text data may include spoken text items and sound text items. The spoken text items may indicate or represent the speech or spoken words (e.g., actor's lines, narrator's lines, reporter's statements, etc.) in the audio content for the content item. The sound text item may indicate or represent sounds that are occurring (e.g., explosion, boom, soft music playing, car horn honking, etc.) within the audio content for the content item.

For example, the text data may include sound text indicators. The sound text indicators may provide an indication as to when the text data is for a sound text item rather than a spoken text item. For example, the sound text indicator can be parentheses “( )” or brackets “[ ]” with the sound text item in between the parentheses or brackets. For example, the sound text indicator can be another form of symbol or indicator that indicates the information is associated with a sound text item. For example, a computing device (e.g., the comparator module 114 of the audio evaluation engine 111, computing device 110, or computing device 190) may detect the sound text indicator when evaluating the text data associated with the audio content and may determine to skip or not evaluate the sound text item within the sound text indicator as the sound text item is not associated with spoken words within the audio content for the content item.

The text data may include presentation start times and presentation end times. Each presentation start time may indicate the time within the content item that the text data item should be displayed or begin to be displayed (for rolling text) with the video content for the content item. For example, the presentation start time may be a clock, timer, or counter associated with the runtime for the video content for the content item. For example, the presentation start time may be during the same time within the audio content that the spoken words or sounds associated with the particular text item occurs. In other examples, the presentation start time may be before (e.g., 0.01-10 seconds before) or after (e.g., 0.01-10 seconds after) the spoken words or sounds associated with the particular text item occurs.

The text data may include presentation end times. Each presentation end time may indicate the time within the content item that the text data item is no longer displayed and is removed from the video content of the content item. For example, the presentation end time may be a clock, timer, or counter associated with the runtime for the video content for the content item.

For example, a computing device (e.g., the comparator module 114 of the audio evaluation engine 111, the computing device 110, or the computing device 190) may determine a text data item within the text data. For example, the computing device 114 may determine the text data item is associated with speech (e.g., a spoken text item). For example, the computing device may determine the text data item is associated with speech based on the text data item not including one or more sound text indicators or based on another form of indicator that indicates the text data item is a spoken text item. The computing device, based on determining the text data item is associated with speech, may determine the presentation start time and/or presentation end time for the spoken text item of the text data.

Audio content for the content item may be received. For example, audio content for one or more content segments of the content item may be received. For example, the audio content may be received by the audio evaluation engine 111, the computing device 110, or the computing device 190. For example, the audio content may be received based on the text data item. For example, the audio content for the content item may be received based on the presentation start time and/or the presentation end time for the spoken text item in the text data. For example, the audio content for the one or more segments of the content item may be received based on the presentation start time and/or the presentation end time for the spoken text item in the text data. For example, the audio content may be for one or more segments of the content item that have an output time that is between the presentation start time and the presentation end time for text data item (e.g., the spoken text item) within the text data and/or within a predetermined amount of time before the presentation start time or a predetermined amount of time after the presentation end time for the spoken text item in the text data. For example, the predetermined amount of time may be 5 seconds, 10 seconds, 20 seconds, or any other amount of time.

At 815, one or more spoken words in the audio of the audio content may be converted to converted audio text. For example, the audio (e.g., audio data) of the audio content may be converted by the audio evaluation engine 111 (e.g., the speech-to-text module 112), the computing device 110, or the computing device 190. For example, the computing device may determine one or more spoken words within the audio of the audio content for the content item (e.g., the one or more determined content segments of the content item). For example, the computing device may invoke the speech-to-text module 112 to convert the audio of the received audio content to converted audio text (e.g., the audio is converted to series of text that corresponds to the speech or spoken words in the audio and may, in some examples, also provide a description of the sounds, scenes, music being played within the audio of the received audio content). For example, the conversion of the audio content (e.g., one or more segments of audio content) may occur for the audio content at or near the corresponding presentation start time within the audio content. For example, the time period of the audio of the audio content converted from speech to converted audio text may be based on the presentation start time for the spoken text item. For example, the time period may include a predetermined amount of time before and after the presentation start time. For example, the time period to evaluate in the audio content may be based on a predetermined amount of time before the presentation start time and a predetermined amount of time after the presentation end time for the spoken text item in the text data. For audio content comprising multiple channels of audio content for each content segment, the computing device may invoke the speech-to-text module 112 to convert audio for each channel of audio content to converted audio text, may only convert a portion of the channels of the audio content (e.g., the center, left and right channels) to converted audio text, or only convert audio for a single channel (e.g., the center channel) of the audio content to converted audio text.

At 820, the text data may be compared to the converted audio text to determine a first portion of the audio content. For example, the first portion of the audio content may comprise audio (e.g., converted audio text) that corresponds to (e.g., matches) or is associated with the text data. For example, the determination may be made by the comparator module 114, the computing device 110, or the computing device 190. For example, the determination may be based on the text data and/or the converted audio text for the audio content (e.g., the one or more content segments). For example, the audio for the first portion of the audio content may be determined to correspond to or be associated with the text data based on at least a portion of the converted audio text for the audio content (e.g., one or more content segments of the audio content) corresponding to (e.g., matching or substantially matching) or being associated with the spoken text item of the text data. For example, determining the audio for the first portion of the audio content corresponds to or is associated with the text data may comprise determining the text data matches or substantially matches the converted audio text derived from one or more spoken words in the first portion of the audio content. For example, determining the audio for the first portion of the audio content corresponds to (e.g., matches or substantially matches) or is associated with the text data comprises determining a portion of the converted audio text corresponds to or is associated with the text data. For example, based on the correspondence or association, the computing device may determine the converted audio text derived from the one or more spoken words in the audio of the audio content for the content item (e.g., the one or more content segments of the content item) matches at least a portion of the text data. For example, the converted audio text derived from audio for the first portion of the audio content that corresponds to or is associated with the text data. For example, the audio for the first portion of the audio content may also include non-speech audio (e.g., background sounds, background music, car honking, explosion, door knock, etc.).

For example, based on the text data (e.g., the spoken text item) the computing device may determine that the text data corresponds to or is associated with the converted audio text derived from the one or more spoken words within the audio for the portion of the audio content (e.g., in the one or more content segments of the audio content). For example, the computing device, (e.g., the comparator module 114) may compare the spoken text item to the converted audio text determined by the speech-to-text module 112 from the audio of the audio content for the content item (e.g., one or more segments of the content item) to determine if any portion of the converted audio text corresponds to (e.g., matches or substantially matches) or is associated with the spoken text item of the text data. For example, a portion of the converted audio text may correspond to or be associated with the spoken text item if the correspondence (e.g., matching or substantial matching) between the converted audio text and the spoken text item satisfies a correspondence threshold. For example, the correspondence threshold may be any value, such as any value between 50%-100%. For example, 50% correspondence between the converted audio text and the spoken text item in the text data may occur when half the words in the spoken text item match the words and/or the presentation order within at least a portion of the converted audio text. For audio content that includes multiple channels of audio content for the content item, the computing device may evaluate the audio for one or more of the channels of audio content to determine which channel or channels of the audio content include converted audio text that corresponds to or is associated with the spoken text item.

For example, the computing device may evaluate audio for all of the channels of the audio content for the content item (e.g., the one or more content segments of the content item) to determine which channel or channels of audio for the audio content included converted audio text that corresponds to or is associated with the text data. For example, the computing device may evaluate only a portion or subset of the channels of the audio for the audio content to determine which channel or channels of audio for the audio content include converted audio text that corresponds to or is associated with the text data. For example, the portion of the channels may comprise one or more of the center channel the left channel and the right channel of audio content. For example, the potion of the channels to be evaluated may not include one or more of the LFE channel, the surround right channel, the surround left channel, or any channel of audio content designated for the back left and back right speakers in a surround sound system. These channels may not be a portion of the channels evaluated due to the reduced likelihood that spoken words in the audio content are to be output on those channels of the audio content, and, as such, are less likely to have converted audio text that corresponds to or is associated with the spoken text items.

For example, the computing device may prioritize evaluating audio for one or more channels of the audio content over audio for one or more other channels of the audio content. For example, the audio for the center channel of audio content for the one or more content segments may be prioritized to be evaluated first to determine if the center channel of audio includes any converted audio texted derived from speech or spoken words on the center channel of audio content that corresponds to or is associated with spoken text items. Prioritizing the audio for the center channel of the audio content may be based on the higher likelihood that spoken words or speech in the audio content are more likely to be output from the center channel of audio content than any other channel of the audio content. For example, the audio for the center channel, the left channel, and the right channel may be prioritized, over audio for any other channels of the audio content, to be evaluated for converted audio text derived from audio of the audio content for those center, left and right channels that corresponds to or is associated with the text data.

For example, the computing device may determine the converted audio text, derived from audio for the first portion of the audio content, corresponds to or is associated with the text data by determining audio for a first portion of the plurality of the channels of audio content comprise one or more spoken words or speech in the audio data for the first portion of the channels of the audio content that are converted to converted audio text and determined to correspond to (e.g., match or substantially match) or be are associated with the text data.

For example, based on the audio for the first portion of the audio content (e.g., at least a portion of the converted audio text) being determined to correspond to or be associated with the text data (e.g., the spoken text item in the text data), the computing device (e.g., the comparator module 114) may determine an output time for the audio content corresponding to the corresponding or associated converted audio text. For example, the computing device may determine the start time for the first portion of the audio content and the end time for the first portion of the audio content. For example, the computing device may determine the start time for when the spoken words (e.g., the converted audio text) within the audio content that correspond to or are associated with the text data begin to be spoken and when the spoken words (e.g., the converted audio text) corresponding to or associated with the text data end being spoken to determine the particular time range within the content item (e.g., the audio of the audio content for one or more segments of the content item) that the spoken words are output. For example, the start time and the end time may be clock references (e.g., times) or counter references and may be based on the beginning of the content item or another time reference. For example, the computing device, based on the start time and the end time, may determine the portion of the content item (e.g., the one or more segments of the audio content (or segments and channels of the audio content)) that includes the converted audio text, derived from the audio for the first portion of the audio content, that corresponds to or is associated with the text data.

At 825, a second portion of the audio content for the one or more content segments may be removed or filtered out. For example, the removal or filtering may be caused or conducted by the filter/audio modifier module 115, the computing device 110, or the computing device 190. For example, the second portion of the audio content may or may not include the audio for the first portion of the audio content (e.g., the converted audio text) corresponding to or associated with the text data.

For examples where multiple channels of the audio content are provided for each of the one or more segments of the content item, the second portion of the audio content may be removed or filtered by removing, deleting, muting, not playing, and/or modifying the audio for the one or more channels of the audio content that did not include spoken words or speech, that when converted to converted audio text, did not correspond to or were not associated with the text data. For example, the following channels of audio content may be provided for each content segment: R channel audio content, L channel audio content, C channel audio content, LFE channel audio content, Rs channel audio content, and Ls channel audio content. The computing device may determine that the C channel audio content includes the audio (e.g., the converted audio text) for the first portion of the audio content corresponding to or associated with the text data (e.g., the C channel audio content includes one or more spoken words or speech converted to converted audio text that correspond to or are associated with the text data). This may be for one or more content segments of the content item depending, for example, on the start time and the end time. The computing device may determine that the audio for the R, L, LFE, Rs and Ls channels of audio content do not include audio converted to converted audio text that corresponds to or is associated with the text data (e.g., the channels do not include the spoken words or speech that, when converted to converted audio data, correspond to or are associated with the text data but may include other sound data). The computing device may create a new track of audio for the content item (e.g., the one or more content segments of the content item). The new track of audio may comprise audio for one channel or multiple channels (e.g., all channels). In another example, the computing device may modify the existing tracks of audio for the content item (e.g., one or more content segments of the content item).

For example, the computing device may remove or filter the audio for the R, L, LFE, Rs, and Ls channels of audio content for the content item (e.g., those one or more content segments of the content item). For example, the computing device may generate a new audio track for the content item (e.g., one or more content segments of the content item) whereby the C channel of audio content, or a portion of the C channel audio content, is included in the new audio track for the one or more content segments and the R, L, LFE, Rs, and Ls channel audio content are not included or the C channel audio data is replicated for output on the R, L, LFE, Rs, and Ls channels by replicating the C channel audio content for each of the other channels of audio content. This may occur in a single audio track that includes the six channels of audio content or in six audio tracks, one for each of the R, L, LFE, Rs, Ls, and C channels of audio content for the content item (e.g., one or more content segments of the content item). The computing device may create the new audio track or tracks by muxing or transcoding the audio for the content item (e.g., the one or more content segments) a second time to create the new audio track or tracks. The new track or tracks may then be included with and/or associated with the portion of the content item (e.g., the one or more segments of the content item) that included the audio data of the spoken words that, when converted to converted audio text corresponded to or were associated with the text data). These new audio tracks or tracks may be provided as an alternative option for those one or more segments along with the original tracks of audio for the content item (e.g., the one or more segments of the audio content for the content item).

In addition, or in another example, the computing device may modify the manifest for the content item (e.g., the one or more content segments) to include an indication (e.g., URL or storage location) for the content item (e.g., the one or more content segments) of one or more alternative sets of audio tracks (e.g., the C channel of audio content or a booth recording that includes a spoken-voice only track, which may be provided by the content source) for selection and output when the version of the content item for those with difficulty hearing or hearing loss is selected.

For examples where the original audio tracks for the content item may be modified (rather than creating new tracks that are included with the original audio tracks) to remove, filter, mute or remove the non-spoken words in the audio data for the content item, the computing device may delete or mute or indicate that those channels of audio content (e.g., the R, L, LFE, Rs, and Ls channels) should be muted within, for example, the metadata associated with the content item (e.g., within the metadata associated with one or more content segments of the content item). For example, when the audio for the channels of audio content are removed, muted, or deleted, the audio content associated with those channels will not be output at the respective speaker position when the content item (e.g., the one or more segments of the content item) are output at a user device (e.g., computing device 190). For example, the computing device may remove or filter the second portion of the audio content by modifying one or more of the R, L, LFE, Rs, or Ls channels of audio content. For example, the computing device may replace the audio content for one or more of the R, L, LFE, Rs, or Ls channels with the audio content for the C channel. As such, the computing device may replace the second portion of the audio content in certain channels with audio (e.g., the converted audio text from the audio) for the first portion of the audio content from another channel that included spoken words or speech that, when converted to converted audio text, was determined to correspond to or be associated with the text data. This will further remove the audio content that is associated with non-speaking audio and replace it with additional sources of the audio content that includes the spoken words in the audio content. Those of ordinary skill in the art will recognize that the specific channels described above are for example purposes only and that different channels and different groups of channels may be included in and include the first portion of the audio content or the second portion of the audio content in other examples.

For example, the audio for the second portion of the audio content may be removed or filtered using auto-tuning. For example, the computing device may identify a waveform in the first portion of the audio content that corresponds to or is associated with (e.g., the audio data representing) the spoken words in the audio content (e.g., the audio) that, when converted to the converted audio text for first portion of the audio content, was determined to be corresponding to or associated with the text data. For example, the computing device may clean up the waveform, to make the spoken words in the audio data clearer or easier to hear or understand when output. For example, the computing device may remove or filter out the second portion of the audio content by deleting other waveforms associated with other audio data that are also occurring between the start time and the stop time of the first portion of the audio content. For example, removing or filtering out audio for the second portion of the audio content may comprise removing or filtering out all audio that did not include speech or spoken words that, when converted to converted audio text, were determined to be corresponding to or associated with the text data in the audio content for the content item (e.g., the one or more content segments of the content item). This may occur when new tracks are being created or when the original tracks are being modified.

The computing device may also modify the audio for the first portion of the audio content that includes speech or spoken words that, when converted to converted audio text, was determined to correspond to or be associated with the text data. For example, the computing device may modify one or more of the frequency, pitch, or volume of the first portion of the audio content that included the converted audio text that was determined to be corresponding to or associated with the text data. For example, the computing device may increase the volume of the audio for the first portion of the audio content to make it easier to hear the spoken words within the first portion of the audio content. The computing device may increase or decrease the frequency of the audio in the first portion of the audio content to a frequency range that is easier for certain users to hear and recognize. The filtered or modified audio content (e.g., for the one or more segments of the content item), as well as the associated video content (e.g., for those segments of the content item), may be sent to a user device (e.g., the computing device 190) and output at the user device. This may occur when new tracks are being created or when the original tracks are being modified.

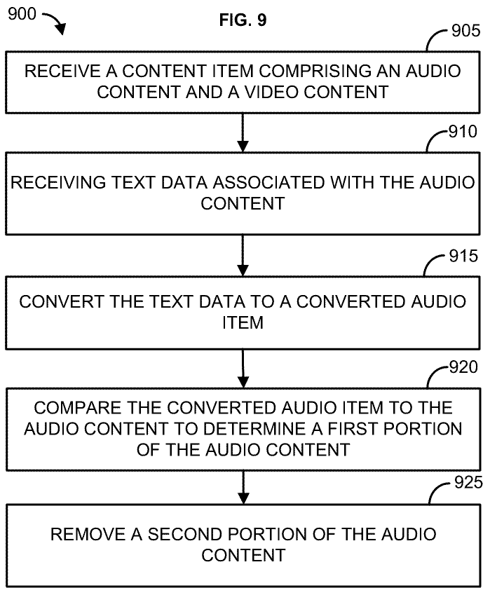

FIG. 9 shows a flowchart of an example method 900 for modifying audio content for a content item. For example, the audio content may be modified by a computing device (e.g., the control device 111, the computing device 110, or the computing device 190). For example, at 905, a content item may be received by computing device. For example, the content item may be received from one or more content sources 102. The content item may include video content and/or audio content. The audio content may comprise audio (e.g., audio data). The audio content may be associated with video content for a content item such that the audio content and the video content are configured to be output with one another. The audio content may include one or more channels of audio content for the content item. For example, the audio content may include a plurality of channels of audio content associated with a surround sound output objective. For example, the audio content may include 5, 6, 7, 8, or more channels of audio content for the content item. For example, the audio content and the video content may be divided into a plurality of content segments for the content item. For example, the computing device 110, via the segmenter 131, may divide the video content into a plurality of video content segments (e.g., video segments) and the audio content (e.g., each channel of the audio content or all of the channels of the audio content combined) into a plurality of audio content segments (e.g., audio segments). The plurality of content segments may be multiplexed segments, having video content and audio content (e.g., each channel of the audio content or all of the channels of the audio content combined) in one segment or non-multiplexed segments, having separate video content segments and audio content segments (e.g., one or multiple channels of audio content in each content segment). For example, the non-multiplexed audio content segment may include the audio data for each channel of the audio content for the corresponding video segment.

At 910, text data associated with the audio content of the content item may be received. For example, the text data may be received by the audio evaluation engine 111, the computing device 110, the computing device 190 or any other computing device. The text data may be associated with speech or spoken words. For example, the received text data may be text data associated with one or multiple portions (e.g., segments) of the content item. For example, the text data may be encoded into the transcoded content items 121 by the encoder 120. For example the content (e.g., each or a portion of the content segments generated by the segmenter 131) may include corresponding text data. The text data may be part of the content (e.g., respective content segments) or separately stored in the text data 139 portion of the data storage device 132. For example, the text data may include closed-captioning data adhering to the CEA-608/EIA-708 closed-captions format. For example, the text data may enable a decoder (e.g., at the computing device 190) to decode the content item (e.g., a particular content segment) and present the corresponding video content and audio content with the text data associated with video content and/or audio content embedded therein.

For example, the text data may include spoken text items and sound text items. The spoken text items may indicate or represent the speech or spoken words (e.g., actor's lines, narrator's lines, reporter's statements, etc.) in the audio content for the content item. The sound text item may indicate or represent sounds that are occurring (e.g., explosion, boom, soft music playing, car horn honking, etc.) within the audio content for the content item.

For example, the text data may include sound text indicators. The sound text indicators may provide an indication as to when the text data is for a sound text item rather than a spoken text item. For example, the sound text indicator can be parentheses “(” or brackets “[ ]” with the sound text item in between the parentheses or brackets. For example, the sound text indicator can be another form of symbol or indicator that indicates the information is associated with a sound text item. For example, a computing device (e.g., the comparator module 114 of the audio evaluation engine 111, computing device 110, or computing device 190) may detect the sound text indicator when evaluating the text data associated with the audio content and may determine to skip or not evaluate the sound text item within the sound text indicator as the sound text item is not associated with spoken words within the audio content for the content item.

The text data may include presentation start times and presentation end times. Each presentation start time may indicate the time within the content item that the text data item should be displayed or begin to be displayed (for rolling text) with the video content for the content item. For example, the presentation start time may be a clock, timer, or counter associated with the runtime for the video content for the content item. For example, the presentation start time may be during the same time within the audio content that the spoken words or sounds associated with the particular text item occurs. In other examples, the presentation start time may be before (e.g., 0.01-10 seconds before) or after (e.g., 0.01-10 seconds after) the spoken words or sounds associated with the particular text item occurs.

The text data may include presentation end times. Each presentation end time may indicate the time within the content item that the text data item is no longer displayed and is removed from the video content of the content item. For example, the presentation end time may be a clock, timer, or counter associated with the runtime for the video content for the content item.

For example, a computing device (e.g., the comparator module 114 of the audio evaluation engine 111, the computing device 110, or the computing device 190) may determine a text data item within the text data. For example, the computing device 114 may determine the text data item is associated with speech (e.g., a spoken text item). For example, the computing device may determine the text data item is associated with speech based on the text data item not including one or more sound text indicators or based on another form of indicator that indicates the text data item is a spoken text item. The computing device, based on determining the text data item is associated with speech, may determine the presentation start time and/or presentation end time for the spoken text item of the text data.

At 915, the text data (e.g., the spoken text item of the text data) may be converted to a converted audio item. For example, the computing device may invoke the text-to-audio module 113 to convert the spoken text item of the text data of the content item (e.g., one or more segments of the content item) into a converted audio item comprising an audio rendition of the spoken text item (e.g., the text data). The computing device (e.g., the comparator module 114) may, based on one or more of the presentation start time and presentation end time for the particular spoken text item, determine a time period for a portion of the audio content for the content item to evaluate. For example, the time period may include a predetermined amount of time before and after the presentation start time. For example, the time period may include a predetermined amount of time before the presentation start time and a predetermined amount of time after the presentation end time for the particular spoken text item. For example, the predetermined amount of time may be 5 seconds, 10 seconds, 20 seconds, or any other amount of time.

Audio content for the content item may be received or determined. For example, audio content for one or more content segments of the content item may be received or determined. For example, the audio content may be received or determined by the audio evaluation engine 111, the computing device 110, or the computing device 190. For example, the audio content may be received or determined based on the text data item. For example, the audio content for the content item (e.g., the one or more content segments of the content item) may be received based on the presentation start time and/or the presentation end time for the spoken text item in the text data. For example, the audio content for the content item (e.g., the one or more segments of the content item) may be received or determined based on the presentation start time and/or the presentation end time for the spoken text item in the text data. For example, the audio content may be for the portion of the content item (e.g., one or more segments of the content item) that have an output time that is between the presentation start time and the presentation end time for text data item (e.g., the spoken text item) within the text data and/or within a predetermined amount of time before the presentation start time or a predetermined amount of time after the presentation end time for the spoken text item in the text data. For example, the predetermined amount of time may be 5 seconds, 10 seconds, 20 seconds, or any other amount of time.

At 920, the converted audio item may be compared to audio for the audio content item to determine a first portion of the audio content. For example, the first portion of the audio content may comprise audio that corresponds to or is associated with the text data (e.g., the converted audio item). For example, the comparison may be made by the comparator module 114, the computing device 110, or the computing device 190. For example, the comparison may be based on the converted audio item (e.g., of the text data) and/or the audio of the audio content (e.g., for the one or more content segments) of the content item. For example, the audio for the first portion of the audio content may be determined to correspond to or be associated with the text data based on at least a portion of the audio content for the content item (e.g., one or more content segments of the content item) corresponding to or being associated with (e.g., matching or substantially matching) the converted audio item of the text data. For example, determining the audio for the first portion of the audio content corresponds to or is associated with the text data comprises determining the converted audio item (of the text data) matches or substantially matches one or more spoken words in the audio of the first portion of the audio content.

For example, the computing device, (e.g., the comparator module 114) may compare the converted audio item to the audio of the audio content for the content item to determine if any portion of the converted audio item corresponds to or is associated with (e.g., matches or substantially matches) all or a portion of the audio in the audio content during the evaluated time period. For example, the converted audio item may correspond to or be associated with the at least a portion of the audio for the audio content for the content item if the correspondence (e.g., matching) between the converted audio item and the audio for the audio content satisfies a correspondence threshold. For example, the correspondence threshold may be any value, such as any value between 50%-100%. For example, 50% correspondence between the converted audio item and the audio for the audio content for the content item may occur when the audio for half the words in the audio content for the content item match words and/or presentation order within at least a portion of the converted audio item (of the text data). For audio content that includes multiple channels of audio content for the content item, the computing device may evaluate the audio for one or more of the channels of audio content to determine which channel or channels of the audio content include audio that corresponds to or is associated with the converted audio item (of the text data).

For example, the computing device may evaluate audio for all of the channels of the audio content for the content item (e.g., one or more content segments of the content item) to determine which channel or channels of audio for the audio content correspond to or are associated with the text data (e.g., the converted audio item of the text data). For example, the computing device may evaluate audio for only a portion or subset of the channels of the audio content to determine which channel or channels of audio for the audio content correspond to or are associated with the text data (e.g., the converted audio item of the text data). For example, the portion of the channels may comprise one or more of the center channel the left channel, and the right channel of audio content. For example, the potion of the channels to be evaluated may not include one or more of the LFE channel, the surround right channel, the surround left channel, or any channel of audio content designated for the back left and back right speakers in a surround sound system.

For example, the computing device may prioritize evaluating audio for one or more channels of the audio content over audio for one or more other channels of the audio content. For example, audio for the center channel of audio content for the content item (e.g., one or more content segments of the content item) may be prioritized to be evaluated first. Prioritizing audio for the center channel of the audio content may be based on the higher likelihood that spoken words in the audio of the audio content are more likely to be output from the center channel of audio content than any other channel of the audio content. For example, audio for the center channel, the left channel and the right channel may be prioritized to be evaluated for audio for the audio content corresponding to or associated with the text data (e.g., the converted audio item of the text data) over audio for any other channels of the audio content. For example, the computing device may determine audio for the first portion of the audio content corresponding to or associated with the text data (e.g., the converted audio item of the text data) by determining audio for a first portion of the plurality of the channels of audio content comprise one or more spoken words in the audio (e.g., audio data) for the first portion of the channels of the audio content that correspond to or are associated with the text data (e.g., the converted audio item of the text data).

For example, based on at least a portion of the audio of the audio content being determined to correspond to or be associated with the converted audio item of the text data, the computing device (e.g., the comparator module 114) may determine an output time for the audio in the audio content corresponding to the associated converted audio item. For example, the computing device may determine the start output time for the corresponding or associated audio of the audio content and the end output time for the corresponding or associated audio of the audio content. For example, the computing device, based on the start output time and the end output time, may determine the audio content for the content item (e.g., the audio segments of the audio content for the content item) that include audio corresponding to or associated with the converted audio item of the text data. For example, the audio for the first portion of the audio content may comprise one or more spoken words associated with the text data and non-speech audio (e.g., background sounds, background music, car honking, explosion, door knock, etc.).

At 925, a second portion of the audio content for the content item (e.g., one or more content segments of the audio content for the content item) may be removed or filtered out. For example, the removing or filtering may be caused or conducted by the filter/audio modifier module 115, the computing device 110, or the computing device 190. For example, the second portion of the audio content may or may not include the first portion of the audio content corresponding to or associated with the text data (e.g., the converted audio item of the text data).

For examples where multiple channels of the audio content are provided for the content item (e.g., each of the one or more segments of the content item), the second portion of the audio content may be removed or filtered by removing, deleting, muting, not playing, and/or modifying the one or more channels of the audio content that do not include audio that corresponds to or is associated with the text data (e.g., the converted audio item of the text data). For example, the following channels of audio content may be provided for the content item (e.g., each content segment): R channel audio content, L channel audio content, C channel audio content, LFE channel audio content, Rs channel audio content, and Ls channel audio content. The computing device may determine that the C channel audio content includes the first portion of the audio content corresponding to or associated with the text data (e.g., the C channel audio content includes one or more spoken words that match or substantially match the converted audio item of the text data). This may be for one or more portions of the content item (e.g., one or more content segments of the content item) depending, for example, on the start time and the end time. The computing device may determine that the R, L, LFE, Rs and Ls channels of audio content do not correspond with or are not associated with the text data (e.g., the channels do not include the spoken words that match or substantially match the converted audio items of the text data but may include other sound data). The computing device may create a new track of audio for the content item (e.g., one or more content segments of the content item). The new track of audio may comprise audio for one channel or multiple channels (e.g., all channels). In another example, the computing device may modify the existing tracks of audio (e.g., the audio content) for the content item (e.g., the one or more content segments of the content item).

For example, the computing device may remove or filter the audio for the R, L, LFE, Rs, and Ls channels of audio content for the content item (e.g., those one or more content segments). For example, the computing device may generate a new audio track for the content item (e.g., the one or more content segments) whereby the C channel of audio content, or a portion of the C channel audio content, is included in the new audio track for the audio content (e.g., the one or more content segments) and the R, L, LFE, Rs, and Ls channel audio content (e.g., the content segments for the R, L, LFE, Rs, and Ls, channels) are not included; or the C channel audio data is replicated for output on the R, L, LFE, Rs, and Ls channels by replicating the C channel audio content for each of the other channels of audio content (e.g., each of the content segments for each of the other channels of audio content). This may occur in a single audio track that includes the six channels of audio content or in six audio tracks, one for each of the R, L, LFE, Rs, Ls, and C channels of audio content for the content item (e.g., one or more content segments of the content item). The computing device may create the new audio track or tracks by muxing or transcoding the audio content (e.g., one or more content segments of the audio content) a second time to create the new audio track or tracks for the content item. The new track or tracks may then be included with and/or associated with the content item (e.g., one or more segments of the content item) that included the audio data of the spoken words. These new audio tracks or track may be provided as an alternative option for the content item (e.g., those one or more content segments) along with the original tracks of audio for the one or more segments of the audio content of the content item.

In addition, or in another example, the computing device may modify the manifest for the content item (e.g., one or more content segments of the content item) to include an indication (e.g., URL or storage location) for the content item (e.g., one or more content segments) of one or more alternative sets of audio tracks (e.g., the C channel of audio content or a booth recording that includes a spoken-voice only track, which may be provided by the content source) for selection and output when the version of the content item for those with difficulty hearing or hearing loss is selected.

For examples where the original audio tracks for the content item may be modified (rather than creating new tracks that are included with the original audio tracks) to remove filter, mute or remove the non-spoken words in the audio data for the content item, the computing device may remove, delete, or mute or indicate that those channels of audio content (e.g., the R, L, LFE, Rs, and Ls channels) should be muted within, for example, the metadata associated with the content item (e.g., the metadata associated with the one or more content segments of the content item). For example, when the channels of audio content are muted, removed, or deleted, the audio content associated with those channels will not be output at the respective speaker position when the content item (e.g., the one or more segments of the content item) is output at a user device (e.g., computing device 190). For example, the computing device may remove or filter the second portion of the audio content by modifying one or more of the R, L, LFE, Rs, or Ls channels of audio content. For example, the computing device may replace the audio content (e.g., the one more segments of the audio content) for one or more of the R, L, LFE, Rs, or Ls channels with the audio content (e.g., the one or more segments of audio content) for the C channel. As such, the computing device may replace the audio of the second portion of the audio content in certain channels with the audio of the first portion of the audio content from another channel that corresponds to or is associated with the text data (e.g., the converted audio item of the text data). This will further remove the audio content that is associated with non-speaking audio and replace it with additional sources of the audio content that includes the spoken words in the audio content. Those of ordinary skill in the art will recognize that the specific channels described above are for example purposes only and that different channels and different groups of channels may be included in and include the first portion of the audio content or the second portion of the audio content in other examples.

For example, the audio for the second portion of the audio content may be removed or filtered using auto-tuning. For example, the computing device may identify a waveform in the first portion of the audio content (e.g., one or more segments of the audio content) and associated with (e.g., the audio data representing) the spoken words in the audio content (e.g., the audio of the first portion of the audio content corresponding to or associated with the text data (e.g., the converted audio item of the text data)). For example, the computing device may clean up the waveform, to make the spoken words clearer or easier to understand (e.g., remove background noise) when output. For example, the computing device may remove or filter out the audio of the second portion of the audio content by deleting other waveforms associated with other audio data that are also occurring between the start time and the stop time of the first portion of the audio content (e.g., the one or more segments of the audio content). For example, removing or filtering out the second portion of the audio content may comprise removing or filtering out all audio not corresponding to or associated with the text data (e.g., the converted audio item of the text data) in the audio content for the content item (e.g., the one or more content segments of the content item). This may occur when new tracks are being created or when the original tracks are modified.

The computing device may also modify the audio of the first portion of the audio content (e.g., one or more segments of the audio content) that corresponds to or is associated with the text data (e.g., the converted audio item of the text data). For example, the computing device may modify one or more of the frequency, pitch, or volume of the audio in the first portion of the audio content that corresponds to or is associated with the text data (e.g., the converted audio item of the text data). For example, the computing device may increase the volume of the audio in the first portion of the audio content in an effort to make it easier to hear the spoken words within the first portion of the audio content. The computing device may increase or decrease the frequency of the audio in the first portion of the audio content to a frequency range that is easier for certain users to hear and recognize. The filtered or modified audio content for the content item (e.g., the one or more segments of the content item), as well as the associated video content for the content item (e.g., those segments of the content item), may be sent to a user device (e.g., the computing device 190) and output at the user device. This may occur when new tracks are being created or when the original tracks are modified.

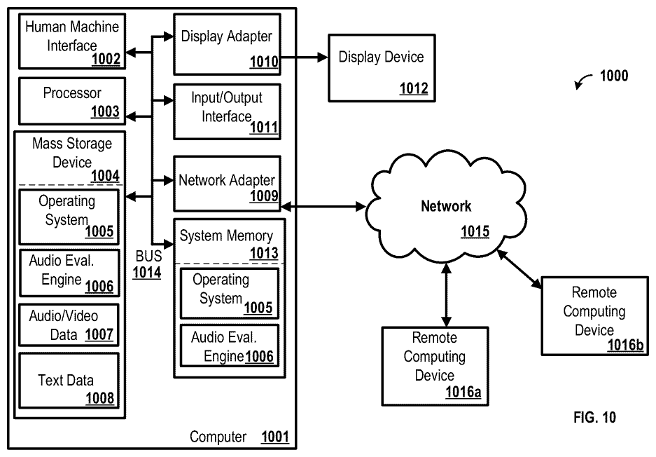

FIG. 10 shows a block diagram of an example system 1000 and computer 1001 for modifying audio content. Any device/component described herein (e.g., the computing device 110, the audio evaluation engine 111, the computing device 190, etc.) may be the computer 1001 as shown in FIG. 10.

The computer 1001 may include one or more processors 1003, a system memory 1013, and a bus 1014 that couples various components of the computer 1001 including the one or more processors 1003 to the system memory 1013. In the case of multiple processors 1003, the computer 1001 may utilize parallel computing.

The bus 1014 may include one or more of several possible types of bus structures, such as a memory bus, memory controller, a peripheral bus, an accelerated graphics port, and a processor or local bus using any of a variety of bus architectures.

The computer 1001 may operate on and/or include a variety of computer-readable media (e.g., non-transitory). Computer-readable media may be any available media that is accessible by the computer 1001 and includes, non-transitory, volatile and/or non-volatile media, removable and non-removable media. The system memory 1013 has computer-readable media in the form of volatile memory, such as random access memory (RAM), and/or non-volatile memory, such as read-only memory (ROM). The system memory 1013 may store data such as audio data and video data 1007 and text data 1008 and/or program modules such as an operating system 1005 and an audio evaluation engine 1006 that are accessible to and/or are operated on by the one or more processors 1003.

The computer 1001 may also include other removable/non-removable, volatile/non-volatile computer storage media. The mass storage device 1004 may provide non-volatile storage of computer code, computer-readable instructions, data structures, program modules, and other data for the computer 1001. The mass storage device 1004 may be a hard disk, a removable magnetic disk, a removable optical disk, magnetic cassettes or other magnetic storage devices, flash memory cards, CD-ROM, digital versatile disks (DVD) or other optical storage, random access memories (RAM), read-only memories (ROM), electrically erasable programmable read-only memory (EEPROM), and the like.

Any number of program modules may be stored on the mass storage device 1004. An operating system 1005 and an audio evaluation engine 1006 may be stored on the mass storage device 1004. Audio data and video data 1007 and/or text data 1008 may also be stored on the mass storage device 1004. The audio data and video data 1007 and/or text data 1008 may be stored in any of one or more databases known in the art. The databases may be centralized or distributed across multiple locations within the network 1015.

A user may enter commands and information into the computer 1001 via an input device (not shown). Such input devices comprise, but are not limited to, a keyboard, pointing device (e.g., a computer mouse, remote control), a microphone, a joystick, a scanner, tactile input devices such as gloves, and other body coverings, motion sensor, and the like. These and other input devices may be connected to the one or more processors 1003 via a human machine interface 1002 that is coupled to the bus 1014, but may be connected by other interface and bus structures, such as a parallel port, game port, an IEEE 1394 Port (also known as a Firewire port), a serial port, network adapter 1009, and/or a universal serial bus (USB).

A display device 1012 may also be connected to the bus 1014 via an interface, such as a display adapter 1010. It is contemplated that the computer 1001 may have more than one display adapter 1010 and the computer 1001 may have more than one display device 1012. A display device 1012 may be a monitor, an LCD (Liquid Crystal Display), light-emitting diode (LED) display, television, smart lens, smart glass, and/or a projector. In addition to the display device 1012, other output peripheral devices may comprise components such as speakers (not shown) and a printer (not shown) which may be connected to the computer 1001 via Input/Output Interface 1011. Any step and/or result of the methods may be output (or caused to be output) in any form to an output device. Such output may be any form of visual representation, including, but not limited to, textual, graphical, animation, audio, tactile, and the like. The display device 1012 and computer 1001 may be part of one device, or separate devices.

The computer 1001 may operate in a networked environment using logical connections to one or more remote computing devices 1016a, 1016b. The remote computing device 1016a, 1016b may be a personal computer, computing station (e.g., workstation), portable computer (e.g., laptop, mobile phone, tablet device), smart television, set-top-box, smart device (e.g., smartphone, smartwatch, activity tracker, smart apparel, smart accessory), a server, a router, a network computer, a peer device, edge device or other common network nodes, and so on. Logical connections between the computer 1001 and a remote computing device 1016a, 1016b may be made via a network 1015, such as a local area network (LAN) and/or a general wide area network (WAN). Such network connections may be through a network adapter 1009. A network adapter 1009 may be implemented in both wired and wireless environments. Such networking environments are conventional and commonplace in dwellings, offices, enterprise-wide computer networks, intranets, and the Internet.

Application programs and other executable program components such as the operating system 1009 and the audio evaluation engine 1006 are shown herein as discrete blocks, although it is recognized that such programs and components may reside at various times in different storage components of the computing device 1001, and are executed by the one or more processors 1003 of the computer 1001. An implementation of the audio evaluation engine 1006 may be stored on or sent across some form of computer-readable media. Any of the disclosed methods may be performed by processor-executable instructions embodied on computer-readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
receiving a content item comprising an audio content and a video content;
receiving text data associated with the audio content, wherein the text data is associated with speech;
comparing the text data to the audio content to determine a first portion of the audio content, wherein the first portion of the audio content comprises audio corresponding to the text data; and
removing a second portion of the audio content.

2. The method of claim 1, further comprising converting the text data to audio data, wherein to determine the first portion of the audio content comprises determining a portion of the audio content that corresponds to the audio data.

3. The method of claim 1, further comprising converting the audio content to converted audio text, wherein to determine the first portion of the audio content comprises determining a portion of the converted audio text corresponds to the text data.

4. The method of claim 1, further comprising determining, based on the text data, that the text data corresponds to one or more spoken words within the first portion of the audio content.

5. The method of claim 1, wherein the text data comprises closed-captioning data.

6. The method of claim 1, wherein removing the second portion of the audio content comprises removing all of the other audio not corresponding to the text data in the audio content.

7. The method of claim 1, wherein the audio content comprises a plurality of channels of audio content, wherein to determine the first portion of the audio content comprising audio corresponding to the text data comprises:
determining a first portion of the plurality of channels of the audio content comprising one or more spoken words associated with the text data,
wherein removing the second portion of the audio content comprises removing audio for a second portion of the plurality of channels of the audio content.

8. The method of claim 7, further comprising replacing the removed audio from at least one of the second portion of the plurality of channels with the audio content for at least one of the first portion of the plurality of channels.

9. The method of claim 1, wherein receiving the content item comprises receiving the audio content and the video content for a content segment of the content item.

10. A method comprising:
receiving a content item comprising an audio content and a video content, wherein the audio content comprises a plurality of audio channels;
receiving text data associated with the audio content, wherein the text data is associated with speech;
comparing the text data to the audio content to determine a first portion of the plurality of channels of audio content, wherein the first portion of the plurality of channels of audio content comprises audio corresponding to the text data; and
removing a second portion of the plurality of channels of the audio content.

11. The method of claim 10, wherein the second portion of the plurality of channels of the audio content comprise audio not corresponding to the text data.

12. The method of claim 10, further comprising replacing one or more of the second portion of the plurality of channels of the audio content with the audio of at least one channel of the first portion of the plurality of channels of the audio content comprising the audio corresponding to the text data.

13. The method of claim 10, wherein the audio of the first portion of the plurality of channels of audio content comprises one or more spoken words corresponding to the text data and non-speech audio, wherein the method further comprises removing the non-speech audio from the audio content of the first portion of the plurality of channels.

14. The method of claim 10, further comprising muting the second portion of the plurality of channels of the audio content.

15. The method of claim 10, further comprising converting the text data to a converted audio item, wherein to determine the first portion of the plurality of channels of audio content comprises comparing the converted audio item to the audio content to determine the first portion of the plurality of channels of the audio content, wherein the first portion of the plurality of channels of the audio content comprises audio corresponding to the converted audio item.

16. The method of claim 10, further comprising converting each of the plurality of channels of audio content to converted audio text, wherein to determine the first portion of the plurality of channels of the audio content comprises comparing the text data to the converted audio text to determine the first portion of the plurality of channels of the audio content, wherein the first portion of the plurality of channels of the audio content comprises converted audio text corresponding to text data.

17. A method comprising:
receiving a content item comprising an audio content and a video content;
receiving text data associated with the audio content, wherein the text data is associated with speech;
converting the text data to a converted audio item;
comparing the converted audio item to the audio content to determine a first portion of the audio content, wherein the first portion of the audio content comprises audio corresponding to the converted audio item; and
removing a second portion of the audio content.

18. The method of claim 17, wherein the first portion of the audio content comprises at least a portion of the converted audio item associated with the text data and wherein the second portion of the audio content does not comprise any audio content associated with the converted audio item.

19. The method of claim 17, wherein the text data comprises closed captioning data.

20. The method of claim 17, wherein the audio content comprises a plurality of channels of the audio content, wherein to determine the first portion of the audio content comprises:
comparing the converted audio item to the audio content to determine a first portion of the plurality of channels of the audio content, wherein the first portion of the plurality of channels of the audio content comprise audio corresponding to the converted audio item; and
wherein removing the second portion of the audio content comprises removing the audio content for a second portion of the plurality of channels of the audio content.
